(19) United States
(12) Patent Application Publication
(10) Pub. No.: US 2016/0283676 A1
(43) Pub. Date: Sep. 29, 2016

(54) SYSTEMS AND METHODS FOR INTERACTIVE DIGITAL DATA COLLECTION

(71) Applicant: CKN GROUP, INC., STRONGSVILLE, OH (US)

(72) Inventors: KELLY LYON, STRONGSVILLE, OH (US); SHAWN INMAN, MEDINA, OH (US); WILLIAM SMITH, LAS VEGAS, NV (US); CHESTER E. SUTTERLIN, III, LONGBOAT KEY, FL (US)

(21) Appl. No.: 15/093,015

(22) Filed: Apr. 7, 2016

Related U.S. Application Data
(63) Continuation of application No. PCT/US2014/059540, filed on Oct. 7, 2014.
(60) Provisional application No. 62/003,350, filed on May 27, 2014.
(60) Provisional application No. 61/887,949, filed on Oct. 7, 2013.
(60) Provisional application No. 61/947,625, filed on Mar. 4, 2014.
(60) Provisional application No. 62/029,421, filed on Jul. 26, 2014.

(51) Int. Cl. G06F 19/00

(52) U.S. Cl. CPC G06F 19/328; G06F 19/322; G06F 19/363

(57) ABSTRACT

The present invention relates to a system and method for a digital data collection software in which a handheld electronic device collects and integrates one or more forms of data for outcome reporting. The various modules within the software can provide a patient-friendly and/or physician-friendly user interface for collecting various forms of data. The data collection templates, standardized reports and surveys can comprise consecutive predefined or custom questions or checklists, where the answers may be entered by using touch screen features, nested in menus or submenus, 3D virtual anatomical models, audio and/or visual cues. A permanent record can be generated from the collected data, where the permanent record can be synchronized for later manipulation such as optimization of the data collection template, production of reports or data analysis. All permanent records can desirably have redundant storage and compliant encryption methods.

### CROSS-REFERENCE TO RELATED APPLICATIONS

The application is a U.S. continuation application of International Application PCT/US2014/059540, with an international filing date of Oct. 7, 2014, which claims the benefit of U.S. Provisional Application No. 62/003,350; filed May 27, 2014; entitled “Tools and Methods for Assessing Surgical Performance;” and U.S. Provisional Applications No. 61/887,949; filed Oct. 7, 2013; U.S. Provisional Application No. 61/947,625; filed Mar. 4, 2014; and U.S. Provisional Application No. 62/029,421; filed Jul. 26, 2014; each of which are entitled “Systems and Methods for Interactive Digital Data Collection.” The disclosures of each are hereby incorporated herein by reference in their entireties.

### TECHNICAL FIELD

The present invention relates generally to devices, systems and methods for collecting, aggregating, analyzing and reporting medical information and related extensible data from preoperative follow-up to post-operative follow-up for medical procedures using an interactive dynamic interface. More particularly, the various devices, systems and methods described herein facilitate patient throughput, reduce clinician workload and improve clinical efficiency by providing an easily-navigable and simple interface for collecting patient data and providing clinical reports coupled to a powerful server architecture for aggregating, analyzing and reporting extensible medical data using a variety of interactive dynamic interfaces.

### BACKGROUND OF THE INVENTION

In recent years, medical records and patient data have been transitioning from physical records (i.e., paper, film and printout) to electronic records (i.e., electronic or “digital data capture” record formats) for a variety of reasons. In addition to various governmental mandates and regulatory schemes (i.e., the Health Information Technology for Economic and Clinical health Act of 2009—“HITECH”—or the Patient and Protection and Affordable Care Act of 2010—PPACA), the healthcare market has begun to realize the advantages of electronic records over traditional record keeping. For example, electronic medical records can be accessed much more easily than their physical counterparts, including allowing for remote access by multiple individuals simultaneously. Electronic records can be more easily copied, and the use of proper backup copies and security technology can render electronic records significantly more durable than physical copies. In addition, electronic records can be quickly and easily queried, depending upon how the data is stored, and the individual data contained therein can be utilized to answer virtually any query posed to it. These and many other factors have been significant contributors for the push to digitize medical data, and have spawned a wide variety of robust digital data collection technology systems with various objectives to improve patient documentation, advance clinical decision support, improve outcome reporting and increasing access to data.

Traditional data collection methods have proven to be woefully ineffective in our modern society, mainly due to the fact that they typically require an intermediary (i.e., a human record keeper) to gather, track, and query patient data, which is thus accomplished in an efficient and ineffective manner. Traditional medical data collection methods are administered in a wide variety of ways, such as written surveys, telephone surveys, mail surveys, face-to-face surveys (i.e., focus groups), and others. In many cases, survey questions are given to a patient and the patient's answers are recorded by the record-keeper. In other cases, the patient may write survey answers on a physical copy, which may at some point in the future be transferred to a an electronic database by an employee using scanning or transcription.

Many of the traditional methods of collecting patient data suffer from a variety of disadvantages, which can include factors relating to non-responsiveness, deficiencies with the survey design, complexity concerns and cost (as well as various combinations thereof). For example, a patient may review the written survey and decide to not respond or delay responding to the survey due for a variety of reasons, which might include an inability to understand one or more of the survey questions and/or answers, reflecting an improper complexity in the questions. Other patients may lie on one or more responses. In other instances, the cost to properly design a given survey may be excessively expensive, or the design may be too complex and/or may include a large number of questions. Moreover, it can be extremely costly to change a survey once implemented, which could include the cost to reprint new forms for multiple revision changes. All of these disadvantages can significantly delay entry and/or availability of the medical data for clinicians or other groups to access and analyze the data for business use or to improve the standard of care for their patients.

Recent regulatory schemes such as HITECH and the PPACA have been enacted to stimulate the adoption of electronic health Information technology and use the collected information in a meaningful way. These regulations require physicians and hospitals to exchange health information electronically, desirably eliminating many traditional data collection methods. Unfortunately, the implementation of such new technology strategies has been slow, cumbersome and deemed ineffective, and the electronic data has been difficult to access and analyze.

### BRIEF SUMMARY OF THE INVENTION

Various features of the devices, systems and methods described herein include the realization that the electronic data contained in various electronic healthcare records can be more accurately collected, aggregated, analyzed and quickly utilized by healthcare professionals where much of the data is collected directly from a patient and/or the primary caregiver. The various systems and features herein seek to accommodate a variety of physical, mental, time and/or effort limitations that patients and/or caregivers may possess, especially where (1) the patients are older and/or less technology-savvy individuals, (2) the patients are suffering from age-related deterioration and/or the inability to concentrate on complex tasks, (3) the patient has difficulty reading, hearing, seeing and/or speaking one or more languages associates with the survey, (4) the medical conditions and/or exacerbating factors/co-morbidities which bring the patient to the physician's office may be interfering with the patient's ability to grasp and/or answer even simple healthcare queries, and/or (5) where the individual entering and/or querying data has a limited amount of time and/or effort available to accomplish a desired function. In various embodiments, the patient survey and associated data entry systems desirably provide a variety of information output formats (i.e., both written and audio instructions/questions provided simultaneously by the survey device) as well as a variety of information input formats (i.e., accepting both sensory as well as audio input for patient answers to survey questions or utilize video inputs) that allow patients and/or caregivers to select an optimal combination of information “outputs” and “inputs” to facilitate the patient's completion of the survey and/or the caregiver's entry of relevant data.

Various embodiments greatly simplify the process of inputting data, allowing the data to be directly entered by a patient and/or caregiver in a quick and efficient manner, and thus significantly reducing the opportunity for transcription errors by medical/clerical personnel and/or misunderstanding on the part of the survey proctor. The inclusion of uncomplicated and easy-to-use interfaces provides innovative dynamic interaction with participants, and patient/caregiver data entry facilitates immediate access to patient responses and/or data, even in the midst of the survey and/or data entry process. In various embodiments, survey responses can be collected immediately upon completion of the entire survey, while in other embodiments survey responses can be collected upon completion of an individual survey question or group of questions, or answering of questions through a patient portal. Once data has been collected, it can be transmitted to one or more medical practitioners for immediate use, such as by reception desk personnel to determine the critical nature of treatment required, scheduling and/or ordering of physician interaction with the patient, and/or ensuring the availability of needed personnel and/or equipment. Information may also be transmitted to one or more nurses, nurse practitioners and/or physicians, facilitating the performance of their duties so as to expedite throughput of the patients through the clinical facility.

In various embodiments, patient survey responses and/or caregiver data entries can be reviewed and/or evaluated using an automated and/or semi-automated system (i.e., a “smart” or learning system), with patient responses/data entries falling outside a given set of parameters highlighted or otherwise indicated for further query. For example, if a patient response is incomplete or left blank, the survey itself may identify this deficiency and require the patient to properly complete the question before allowing the survey to be completed. In other cases, front desk personnel may be notified of a deficiency in a given survey. In other embodiments, the physician may be notified of the deficiency. If desired, various embodiments may include the derivation and/or estimation (i.e., a smart or learning system) by the system of a range of acceptable responses from database information of other patients, or the system may utilize information previously obtained from the same patient and/or caregiver to determine a range of acceptable responses.

The various digital data collection methods described herein enable useful data analysis for the treatment of patients and patient populations at unprecedented levels of accuracy and sophistication, and by having immediate access to historical and present patient data, and various analyses thereof, a medical care practitioner such as a clinician may have real-time access to data so that they may improve their patient's standard of care, improve their clinical workflow efficiency, utilize the data in other meaningful ways, and share their patient data so others may react quickly to detected problems. Various embodiments facilitate remote access to various levels of patient data and/or reports, which can include access by primary care clinicians, care-givers and/or patients themselves.

In other exemplary embodiments, the present invention provides systems, methods, and computer readable media that facilitate creation, data aggregation, analysis and outcome reporting by allowing the physician/clinician to input operative patient data using a three-dimensional (3D) virtual model of the spine or pertinent areas of surgery practice (i.e. cardiac, pulmonary, spine, knees, shoulders, hips, and/or a combination thereof). The 3D virtual model may be manipulated by the physician/clinician to identify the targeted area of the body, the implants used, the surgical tools used, the lot numbers of the implants and tools, the orientation of the implants/tools used, complications, and various other component hardware or procedural steps that were planned pre-operatively and that actually occurred operatively for comparative purposes. Furthermore, the data inputted may be collected and stored to establish an operative data library.

Various embodiments of the present invention include digital data collection software application services that empower patients and clinicians to collect, manage and analyze their health care data more efficiently, and more particularly, to utilize the data more effectively with easier outcome reporting. In one exemplary embodiment, the present invention provides systems, methods, and computer readable media that enable the creation, data aggregation, analysis and outcome reporting, where the exchange of data occurs with at least one host data management system and at least one client device. The exchange may comprise a real time exchange or a substantially real time exchange, as well as other protocols, through a wireless system, 3G/4G networks, VPN, and/or Ethernet connection.

In one exemplary embodiment, the present invention provides systems, methods, and computer readable media that facilitate the creation, data aggregation, analysis and outcome reporting, where the exchange of data with a host data management system may be used with various client devices. Such client devices may comprise tablets, smart mobile phones, computers, PDAs, and other mobile computer type devices.

In another exemplary embodiment, the present invention provides systems, methods, and computer readable media that facilitate the creation, data aggregation, analysis and outcome reporting, where the computer readable media, or digital data collection software application, may be used with various mobile operating systems. Depending upon the installed hardware base, the digital data collection software application may be resident on a variety of platforms, including, but not limited to, iOS, Android, Google, Windows, Symbian OS, Palm OS, Blackberry OS, and Ubuntu Touch OS.

In various embodiments, devices, methods, systems and computer readable media are provided that facilitate the creation, data aggregation, analysis and outcome reporting that may be used for a variety of applications. Such applications may include healthcare services, pharmaceutical services, clinical studies, healthcare insurance services, medical device follow-up, and/or combinations thereof.

In another exemplary embodiment, the present invention provides systems, methods, and computer readable media that facilitate the creation, data aggregation, analysis and outcome reporting by allowing the physician/clinician to administer validated, modified-validated and custom questionnaires to their patients from pre-operative visits through long-term post-operative follow-up visits. The software can be designed to identify each type of validated, modified-validated and custom questionnaires as independent modules and/or its corresponding answers within a given database. All data can be stored in a questionnaire data library for future data querying and data analysis by various third-parties, the surgeon/clinician, and/or the software developer. Such separation and identification of questionnaires may allow the software developer to use the data for commercial purposes, including selling, sharing, or contributing data for prospective registries, diagnosis based registries, benchmarking surgeon performance registries, device or drug performance, complication rate registries, and various combinations thereof.

In other exemplary embodiments, the present invention provides systems, methods, and computer readable media that facilitate the creation, data aggregation, analysis and outcome reporting by allowing the software developer to create optional workflow efficiency modules. The optional workflow efficiency modules may include modules such as operative notes, insurance documentation authorization, office visit information and/or reports, preoperative modules, and/or any combinations thereof. These modules may allow the physician/surgeon/staff to enter the necessary patient information into the software, and the system may provide pre-set paragraphs and/or information sets that can be automatically prepopulated to form completed and/or required hospital or patient chart reports. Various embodiments may include features that also provide for electronic signatures by a patient, physician, hospital, insurer, and/or other caregiver, may provide for multi-user and/or sequential user “sharing” features, and/or may include the option for personalization of one or more reports, if desired.

In other exemplary embodiments, the present invention provides systems, methods, and computer readable media that facilitate the creation, data aggregation, analysis and outcome reporting by development of an insurance authorization module. The insurance authorization module may allow for the creation of a separate insurance payor database that stores all relevant preauthorization criterion, policies, and/or procedures, where a physician/clinician and/or staff may request a trial preauthorization packet that details out the specific criterion necessary to substantially guarantee or guarantee approval by the insurance payor. The insurance authorization module will statistically track and analyze submission, resubmission, and/or denials to update the insurance payor database (i.e., a “smart” or learning module).

In other exemplary embodiments, the present invention provides systems, methods, and computer readable media that facilitate the creation, data aggregation, analysis and outcome reporting by development of an optional professional education module (PEM). The PEM may allow third parties to use the module as an electronic media platform, where the third parties may disseminate information to targeted individuals, such as a physician, staff and/or patient. The PEM may utilize the stored de-identified patient identification and the corresponding patient information database or database warehouse to match the targeted disseminated information within the campaign database for accessibility by a physician, staff and/or patient. Furthermore, the PEM may allow for third parties to statistically track and analyze their targeted disseminated information (i.e., campaigns) by accessing the PEM.

In another exemplary embodiment, the present invention provides systems, methods, and computer readable media that facilitate the creation and data aggregation of patient-specific medical health histories and using the aggregated data for targeted dissemination of information to a physician or patient. The computer readable media may be programmed to index the aggregated patient-specific data, including at least one of patient demographics, diagnostic results, family history, office visits, medications, treatments, implants, and/or hospitalizations to disseminate a variety of targeted information to a physician and/or patient. The targeted disseminated information may be used to amend or modify physician selected treatments.

### BRIEF DESCRIPTION OF THE SEVERAL VIEWS OF THE DRAWINGS

FIG. 1 depicts a schematic diagram of one embodiment of the component architecture of the digital data collection software system;

FIG. 2 depicts a flowchart of a method for surgeons to customize their patient administrated surveys;

FIG. 3 depicts a flowchart of a method for user authentication;

FIG. 4 depicts a flowchart of a method for entering new patient information;

FIG. 5 depicts a flowchart of a method for entering existing patient information;

FIG. 6 depicts a flowchart of a method for immediate access of patient data and outcome reporting;

FIG. 7 depicts a schematic diagram of one embodiment of a prompt interface for user authentication;

FIG. 8 depicts a schematic diagram of one embodiment of a user main menu touch-screen option interface;

FIG. 9 depicts a schematic diagram of one embodiment of a user patient look-up screen interface with option to scroll or search for patient information;

FIG. 10A depicts a schematic diagram of one embodiment of a user patient demographic input screen;

FIG. 10B depicts a schematic diagram of FIG. 10A with scrolling sub menus for collecting data;

FIG. 11 depicts a schematic diagram of user patient menu touch-screen option interface;

FIGS. 12A-12D depicts various schematic diagrams of a user pre-operative report screen interface with scrolling sub menus for entering insurance and diagnosis data of a new patient;

FIGS. 13A-13C depicts various schematic diagrams of a user operative report screen interface with scrolling sub menus for entering general operative data of a new patient;

FIGS. 14A-14C depicts various schematic diagrams of a user operative report screen interface with scrolling sub menus for entering operative surgical level data of a new patient;

FIG. 15 depicts a schematic diagram of a patient information confirmation screen;

FIGS. 16A-16C depicts various exemplary schematic diagrams of a patient survey;

FIG. 17 depicts an exemplary view of the patient dashboard snapshot report;

FIG. 18 depicts an exemplary view of the patent dashboard full detail report;

FIGS. 19A-19C depicts an exemplary view of the patient dashboard VAS right leg, left leg and back reports;

FIG. 20 depicts an exemplary view of the patient dashboard Oswestry scores;

FIG. 21 depicts an exemplary view of the patient dashboard Satisfaction report;

FIG. 22 depicts one exemplary embodiment of a 3D virtual anatomical model with skin attached;

FIG. 23 depicts one exemplary embodiment of a 3D virtual anatomical model with musculature;

FIG. 24 depicts various views of one exemplary embodiment of a 3D virtual anatomical model with skeletal system;

FIG. 25 depicts one exemplary embodiment of a 3D virtual anatomical model with highlighted musculature;

FIG. 26 depicts one exemplary embodiment of a 3D virtual anatomical model with segmented musculature and skeleton;

FIG. 27 depicts one exemplary embodiment of a 3D virtual anatomical model of the spine;

FIGS. 28-30 depicts various exemplary embodiments of 3D virtual models of dermatome maps;

FIGS. 31A-31B illustrates examples of general and specific insurance payor policy rules and requirements;

FIG. 32 illustrates one exemplary embodiment of a preauthorization checklist for a specific medical intervention, diagnosis and related codes;

FIGS. 33A-33C illustrate exemplary embodiments of a preoperative visit and insurance authorization summary for a specific medical intervention, diagnosis and related codes; and

FIG. 34 depicts a flowchart of one method for an embodiment of a DDCS insurance payor hosted authorization module;

FIG. 35 depicts a flowchart of one method for an embodiment of a DDCS hosted authorization module;

FIG. 36 illustrates one exemplary embodiment of targeted advertising on the professional education module; and

FIG. 37 illustrates one exemplary embodiment of instructions for use as targeted advertising.

### DETAILED DESCRIPTION OF THE INVENTION

The need for customizable digital data collection in the medical marketplace is compelling and essential in the changing healthcare environment. The employment of such systems can significantly improve clinical utility of patient data with their ability to collect, track, analyze, and present outcomes data for a wide variety of surgical procedures, as well as contribute to improved patient care and patient throughput in a variety of clinical settings. Various embodiments include a unique approach to traditional manual data collection, and focus on simplified, user-friendly customizable digital data collection system using an iPad™ based platform, or other portable electronic device (PED) platforms, where each platform may be wirelessly coupled to server-based components for remote data storage and analysis. The collection and provision of customizable digital data system using a tablet-based platform will desirably allow clinicians and hospitals to gather, track, and query peri-operative data in order to efficiently and effectively quantify surgical outcomes.

The digital data collection software can be highly customizable to allow clinician partners to tailor their data collection, documentation, tracking, and reporting of patient results, or the system can be standardized for physician convenience. The software can also provide numerous advanced features to include tailored patient-friendly software interfaces, custom data analysis reports, and selectable multi-lingual and audio options, each of which desirably require minimal training, interaction and input from the surgeon and medical staff, thus minimizing clinician and office staff workload. Such “patient-driven data collection” can significantly increase a patient's comprehension of survey questions and stimulate quicker response times. For example, patients using simplified medical data surveys could completing questionnaires within 4 to 6 minutes, and the entered data can be immediately available to the clinicians upon the completion of the survey and/or during or after the point that each individual question is completed. In addition, the use of such simplified interface designs can also significantly lower the opportunity for human error when compared to the use of survey data entry personnel using traditional registries.

System Component Architecture

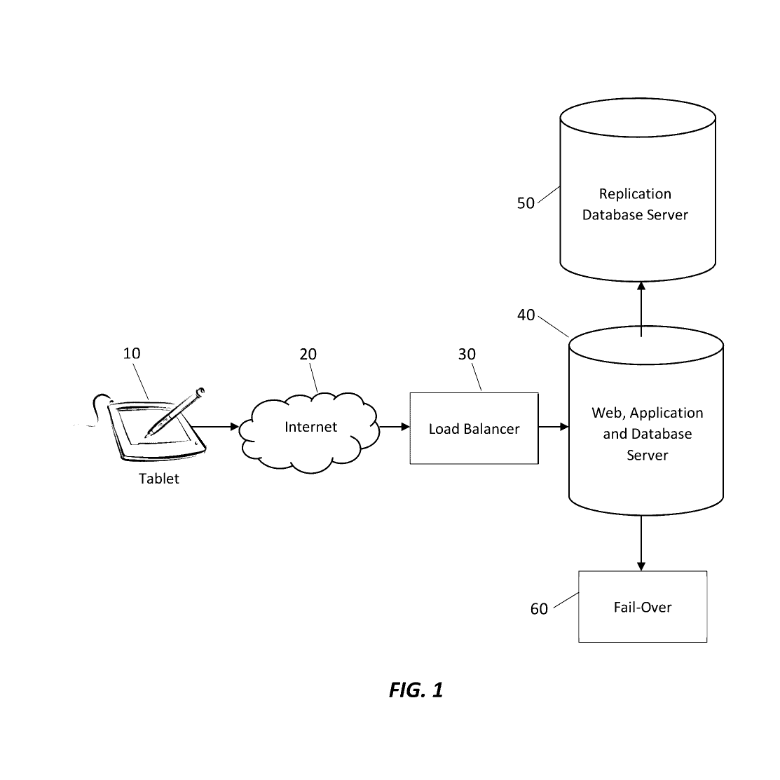

FIG. 1 depicts a schematic diagram of one exemplary embodiment of the various component architecture of a digital data collection software system 5, constructed in accordance with various teachings of the present invention. One or more handheld devices 10 can collect and may temporarily store multiple types of data in its temporary memory for ultimate transmission to further permanent record storage and/or to provide instant access to the data for outcome reporting. Such handheld devices 10 may comprise mobile phones, smart phones, tablet computers, laptops, desktops, personal digital assistants (PDA), and any combinations thereof.

The handheld device 10 desirably communicates through the Internet 20 (or other communication system, which could including a local server without internet access) in preparation for uploading and down loading data to at least one of a temporary memory storage device or system. The handheld device 10 can use one or more methods for communicating through the Internet 20, which may include VPN, cable, WIFI, 3G, 4G, DSL, mobile sharing data connection, dial-up modem or networking, CD-Rom, DVD, floppy disc, flashcard, memory stick or other methods known in the art for data delivery and communication.

Once the handheld device 10 communicates with a server through the Internet 20, the data may be uploaded or downloaded through one or more databases for storing data collected by the handheld device 10. For example, one embodiment of the databases may include a load balancer 30, a web/application/database server (WAD Server) 40, a replication server 50, and a fail-over database 60. The load balancer may be incorporated into the component architecture of the digital data collection software system 5 to operate as a computer networking method for distributing workloads across multiple computing resources, such as mobile phones, tablets, computers, a computer cluster, network links, central processing units or disk drives. The load balancer may be introduced as either a hardware or software feature within the component architecture of the digital data collection software system 5. The main function of a load balancer aims to optimize resource use, maximize throughput, minimize response time, and avoid overload of any one of the resources.

In another embodiment, the component architecture of the digital data collection software system 5 may include a web/application/database server (WAD Server) 40. The WAD server may have multiple functions that are incorporated into one single server or the WAD server may be separated into multiple servers, each having one of more of the WAD server's three individual functions. For example, the web application server portion of the WAD Server 40 may be designed to support both dynamic and static data. With this dual method to support data, it may be considered a pervasive way to access a wide variety of information and applications through their Web browser. However, the software developer may choose to only use a web server (not shown) or an application server (not shown) separately to only access static data and/or dynamic data. In various embodiment, having access to both dynamic and static data can desirably allow the web application server portion to access templates, running programs and accessing databases. Examples of products that may accomplish these functions includes, but are not limited to, Sun Java, Apache, Tomcat, Jetty, etc.

In one alternative embodiment, the database server portion of the WAD Server 40 may be incorporated into the component architecture of the digital data collection software system 5. The database server portion of the WAD Server 40 may perform a variety of tasks such as data analysis, storage, data manipulation, archiving, and other non-user specific tasks. Such database management systems (DBMS) that can be used may comprise one or more of Oracle, DB2, MySQL, and/or any other DBMS systems known in the art for database management.

In another exemplary embodiment, the component architecture of the digital data collection software system 5 may include a replication database server 50. The replication database server 50 may be incorporated as a primary/backup model where one device or process has unilateral control over one or more other processes or devices. For example, the primary database (which may be incorporated in the WAD Server 40) might perform the main computations, storage of data, and/or streaming of a log of updates to a backup (standby) process, which can then take over if the primary database fails. This approach allows active (real-time) storage replication by distributing updates to several physical hard disk databases, one or more of which may be available at a remote location. The active (real-time) storage may assist with obtaining identical data to that contained in the primary database, and without losing any major transactions if the primary database was corrupt and/or nonfunctional/unavailable.

In another exemplary embodiment, the component architecture of the digital data collection software system 5 may include a failover 60. The software manufacturer may include a failover as a data backup operation upon the failure of the primary database and/or replication database server 50 or if the primary database is temporarily shut down for servicing. This may be an important feature to help the software manufacturer and any users to have constant and immediate accessibility to the stored data. The failover 60 may be programmed to back-up data automatically any time of the day and store the secondary or tertiary set of collected data in an on-site or off-site location.

Systems and Methods of Digital Data Collection

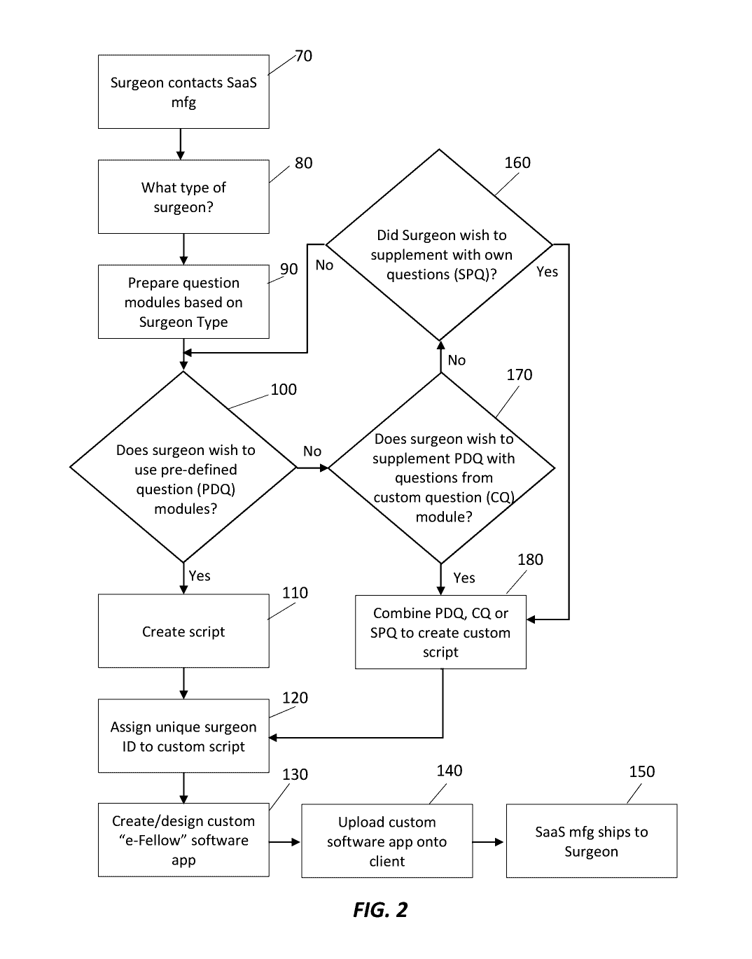

FIG. 2 depicts a flowchart of one exemplary embodiment of a decision process for creating a customized data collection software system for use in various embodiments of the present invention. In this embodiment, a physician (or other medical care provider) and software supplier can initiate contact 70 and the type of physician and/or medical specialty of the physician will be identified 80. The manufacturer can then provide the physician with a series of example or “standard” survey questions and/or question modules 100 (comprising multiple survey questions) that are generally applicable to the particular drug, device, physician type and/or medical specialty 90. If the physician wishes to utilize one or more of the “standard” questions/modules, the manufacturer can then create a survey “script” 110 (or utilize a previously defined script) to create a path or roadmap of the questions for the patient to follow as they complete the survey. Alternatively, if the physician wishes to add, subtract, modify or otherwise alter the standard questions/modules, such as by adding additional pre-defined 160 (i.e., “standard” questions not initially supplied to the physician), custom 170 and/or physician created questions 180, this can be accomplished by the manufacturer and then an appropriate script can be created. As another alternative, if the physician wishes to add one or more personalized survey questions 160, such questions can be added by the manufacturer and then an appropriate script can be created 180. In various embodiments, any physician modifications to a “standard” question/module set can be subsequently added to the “standard” question database for use by other physicians, if desired.

Once a proper script has been created, a unique identifier can be assigned to the script 120, which desirably corresponds to the physician for whom the script has been created. In another embodiment, if the physician desires that a staff member or multiple staff members may require access to the software, a new unique identifier can be provided to the staff member or members while still being associated with the physician unique identifier. A variety of unique identifier methods may be used, such as various one-dimensional (1D), two-dimensional (2D) or three-dimensional (3D) barcodes. If necessary, a custom software application can be created 130 to support the script, or a “standard” software application can be utilized. In various embodiments, the software can be loaded 140 onto a hardware platform such as a tablet computer, and the hardware subsequently shipped to the physician 150 for use in his or her practice. Alternatively, the software developer may choose to have the software loaded, tested and train staff on-site at the physician principal office, clinic or hospital. Another alternative could include the employment of downloadable software, allowing the software to be remotely installed.

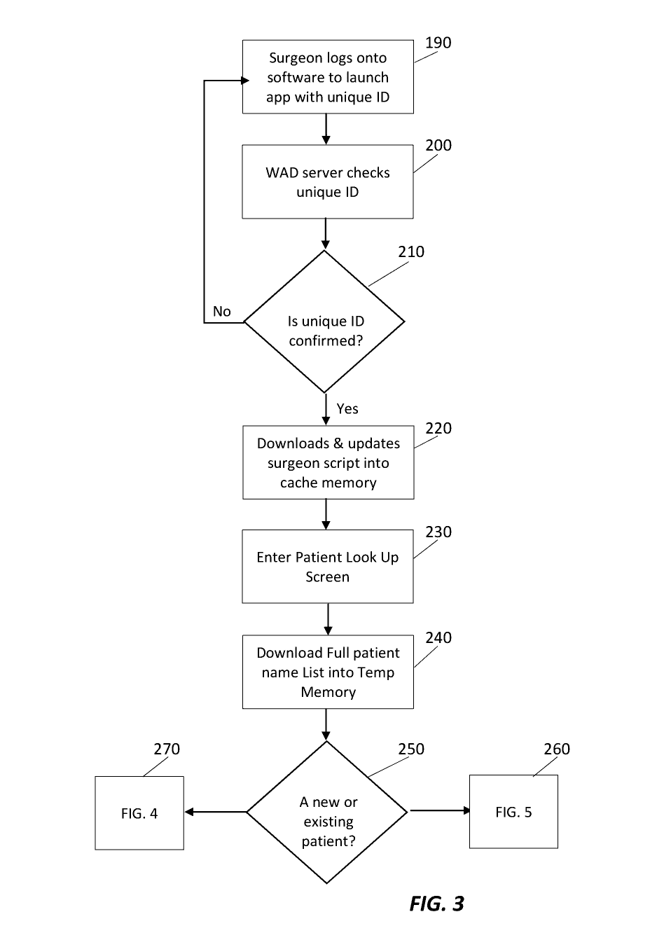

FIG. 3 depicts a flowchart of one exemplary embodiment of a method for user authentication programmed within the software application. In one embodiment, the physician or the physician staff 190 can “power on” or otherwise activate the handheld device to obtain a logon screen. The physician or physician staff 190 can then enter their unique identifier. The WAD server can include various steps programmed to confirm and authenticate 200 the physician's and/or physician staff's unique identifiers. Once the unique identifier is identified 210, the software application can initiate a download and/or upload of any potential software updates, patient scripts and/or data on cache or temporary storage 220. In one embodiment, the physician or the physician staff member may enter the patient look-up screen 230. Desirably, the software developer will have enabled the system to download patient scripts in a temporary manner using transient and/or volatile memory and/or memory storage locations. The patient scripts may be potentially downloaded on the handheld device's temporary storage and/or cache 240, where the information is available for the day to immediate access to the patient history and files, and when the physician or physician's staff logs off, the information may be overridden by any other information—i.e., the scripts are not permanently available on the handheld device. This may be advantageous in case the handheld device is misplaced, lost, or stolen, and third parties will desirably not have access to sensitive patient information. Alternatively, the software developer may decide to preprogram the hardware and operating system of the handheld device, where the patient scripts may be downloaded on a more permanent basis. The permanent storage may be a designated location in the memory where the scripts may be downloaded. However, if authentication fails, the physician or staff members may attempt to re-enter their unique identifier 190 in the log-on screen. At this point, the physician or the physician staff member may choose how to proceed based on the patient status—the software application may have interfaces that may query 250 whether access is required to an existing patient 270 or a new patient 260.

FIG. 4 depicts a flowchart of one exemplary embodiment of a method for entering new patient information 270, as programmed in the software application. In one embodiment, after the physician or the physician's staff enters the new patient screen 280, the physician or the physician staff may enter patient information based on the type of office visit. The software application may include options to enter new patient information if the patient is undergoing a preoperative visit 290, a postoperative visit (which may include immediately postoperative and any follow-ups). If the patient's first office vista is a preoperative visit, 290, the physician and/or physician's staff should desirably enter the patient demographics, and save the information 300. The saving function in the application can inform the software application to proceed to a patient menu that has a variety of selectable options that are immediately accessible to the physician and/or the physician staff, including beginning the survey, operative information, patient dashboard, preoperative assessments, patient demographics, and/or any combination thereof. Other options may be included, such as other patient history, related surgeries, co-morbidities, participating clinical trials, study group memberships and/or comments in the patient menu. Alternatively, the software developer may include options for the physician and/or physician staff to link, sync and/or communicate to any other internal electronic health record system to assist with population of the fields or relevant patient information required in the software application. If some data remains missing, then the physician or physician staff may enter the remaining information.

The physician or the physician staff may enter into the “begin survey” screen 310, which can activate the survey on the handheld device for the patient. The handheld device can then be handed to the patient, which may include features to confirm, at a minimal level, the patient identity 320, and the patient may choose to proceed to the beginning of the survey 330 if the information is correct. The software application may have easy interfaces programmed to facilitate easy and quick answering of the survey. The software application may have touchscreen options, audible options, and/or easy to read text or buttons for the patient at any age and handheld device comprehension. Once the patient has completed the survey 340, the patient, the physician, and/or the physician staff may press the “done” button for optionally caching the survey responses and to proceed to data record storage.

In another embodiment, the software application may be programmed to de-identify sensitive patient information 400, and the software application may assign an automated serialized number 410 associated to the specific patient, physician and/or physician staff. The serialization 410 of the patient can allow permanent data record storage in a database management system (DBMS) within the WADS or a separate DBMS can be added. Also, permanent record storage may occur on-site at the software developer's business or at a remote location to the business.

Alternatively, the software developer may choose to implement a replication server 420 that will simultaneously and actively store information on a separate server. The replication server may provide an additional data storage safety by actively storing data, and streaming a log of updates to a backup (standby) process, which can then take over if the primary database fails. This allows the software developer to have access to real-time storage of identical data that the primary database was in, and without losing any major transactions if the primary database was nonfunctional. Furthermore, the physician and/or the physician staff may log-off the survey screen 430, which the software application may automatically require re-authentication with the relevant unique identifier. In another embodiment, the software developer may also choose to include a fail-over 440 within the system architecture. This allows a further safety of the data that may be stored on-site or at a remote location if the primary DBMS or replication server fails, and/or is hacked.

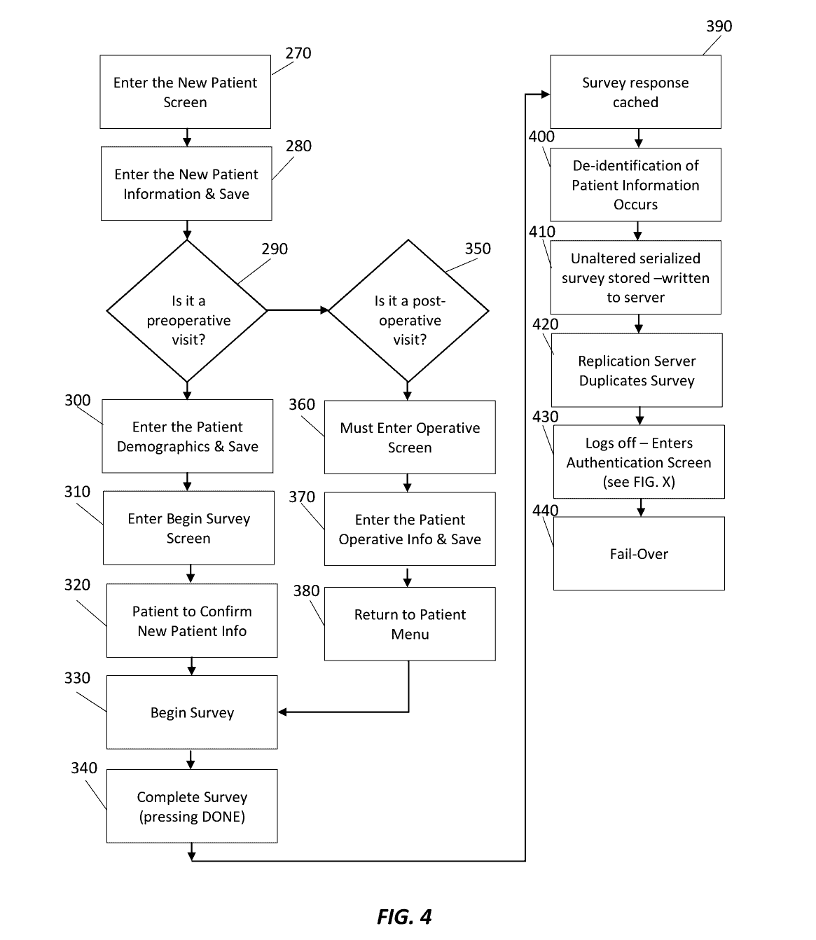

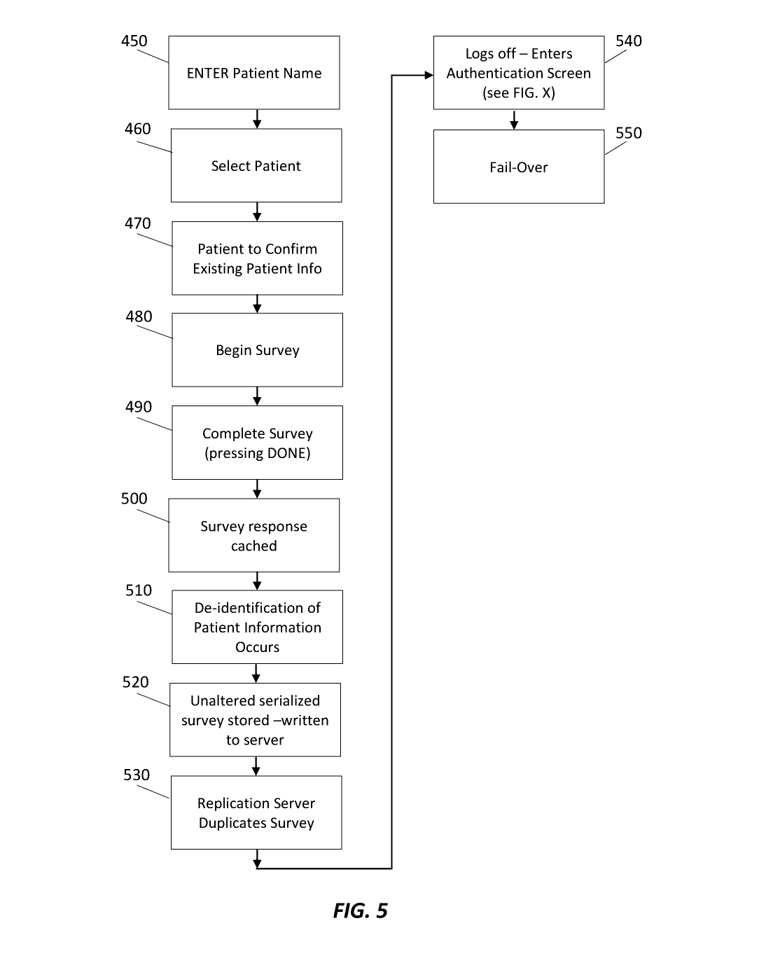

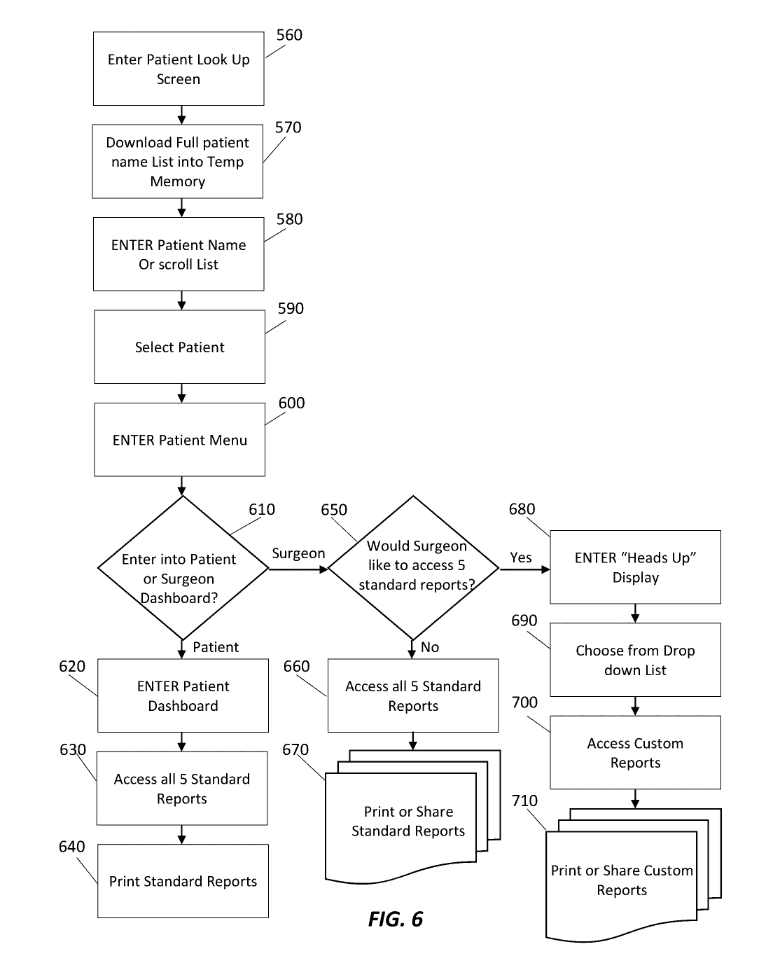

FIG. 5 depicts a flowchart of one embodiment of a method for entering existing patient information as programmed into the software application. In one embodiment, the physician and/or the physician staff may need to access existing patient information. The physician and/or physician staff may enter a patient look up screen or patient search screen 560. The software developer may decide to download patient scripts in temporary manner once the patient look up screen or patient search screen is accessed. The patient scripts may be potentially downloaded on the handheld device's temporary storage and/or cache 570, where the information is available for the day (or some other period) to allow for immediate access to the patient history and files, and when the physician or physician's staff logs off, the information may be overridden by any other information—i.e., the scripts are not permanently available on the handheld device. The physician and/or the physician staff may choose to enter the patient name, view the name on a scrolled list 580 or optionally as a drop down menu.

The physician and/or the physician staff may find and select the patient 590 to be able to enter into the patient menu 600. The patient menu may have a variety of selectable options that are immediately accessible to the physician and/or the physician staff, including beginning the survey, operative information, patient dashboard, preoperative assessments, patient demographics, and/or any combination thereof. Other options may be included, such as a surgeon dashboard, other patient history, related surgeries, or comments in the patient menu. Once the physician and/or physician staff has entered the patient menu screen, they may choose to initiate a patient survey (not shown) for the specific patient office visit, or they may enter the patient dashboard or surgeon dashboard 610.

If the physician and/or physician staff chooses to enter the patient dashboard 620, the software application may include a variety of standard reports 630, such as a snapshot of the most recent survey or history of surveys that highlights the answers where a higher degree of pain or dissatisfaction is noted. It may also include a full detail report of all the medical visits, left leg pain graph, right leg pain graph, back pain graph, Oswestry score graph and satisfaction score graph. All of these graphs may be presented in a bar graph, in a line graph, pie graph and/or present any standard statistical graphs that may show relationships and superimposed on the available graphs, or any other relevant information. These standard reports can allow the surgeon to view whether the patient has improved over time as compared to pre-surgery and through follow-up after the surgery. It is a helpful tool for a physician and/or physician staff to be able to read the reports, and potentially improve the patient standard of care with immediate access to such historical data.

In an alternative embodiment, the physician or physician staff may choose to enter a surgeon dashboard. The surgeon dashboard may be programmed to include more physician and/or physician staff friendly flexibility and increased options, rather than have access to only the standard reports. The physician and/or physician may also have access to the standard reports 660 from the surgeon dashboard to print or share 670 the reports. The physician or the physician staff may “share” a page, a report, multiple reports, patient history or survey responses, and/or any combination thereof to another physician, physician practice, an internal electronic record system, and/or physician staff. The “sharing” may occur through email, text, cloud based file system (i.e., Dropbox), LinkedIn, Facebook, Pinterest, Flipboard, personal note taking software on the handheld device (i.e., S memo or One Note, etc.), and/or any format that allows digital information “sharing.” The software developer may require that “sharing” is encrypted, or requires a password with further authentication to access the sensitive patient information.

Alternatively, the physician and/or physician staff may require unique reports that are not considered standard. The software application may provide a new screen to access the unique and or custom reports 680. The unique reports may be accessible by using a drop down list 690 or a search field to locate the necessary custom report. The physician and/or physician staff can access the custom report to print or share 710 as previously described in the above description.

Patient Interfaces

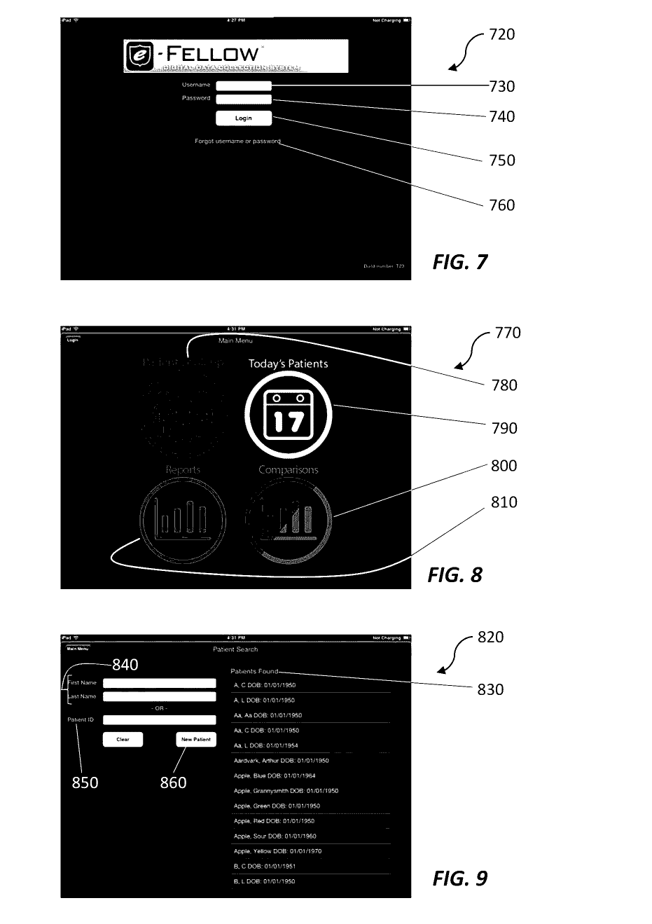

FIGS. 7 through 21 depict various data entry and reporting screenshots of one exemplary embodiment of a Digital Data Collection System (DDCS) constructed and operated in accordance with various features of the present invention. This embodiment includes one or more software applications and/or modules that allow direct patient reporting of outcome measures to assess efficacy of spine care. The software and supporting database can facilitate advanced clinical decision support and increase access to clinical data, quantify procedure outcomes and generate data to support the economics of delivered care. Desirably, the database of patient data will include information from many patients, such as data regarding over 3000 patients in the initial database, as depicted and described herein.

The DDCS is desirably a customizable digital data collection software that can be installed and/or loaded onto a portable electronic device, such as an iPad® tablet computer platform. The software may be manually uploaded through a CD, through a cloud-based system, through the Internet, through an email link, and/or a combination thereof. Such ability to upload the software onto the PED may allow the software developer remote access to modify, delete or view personal software attributes or code. Various embodiments include software modules that are simple to operate, robust and flexible to accommodate the needs of a variety of clinical specialties and/or patients. The DDCS will desirably be easily configured to meet a clinician's personal preferences, allowing the clinician to select from combinations of validated, validated-modified, and/or customizable questionnaires encompassing thousands of potential patient queries that can be stored in a centralized database.

FIG. 7 describes one embodiment of a DDCS launch screen 720. In this launch screen 720, the DDCS security is displayed in this first screen, where the clinician and/or clinician's staff should enter their unique assigned username 730 and password 740. Once the username 730 and password 740 are entered using a login button 750, the DDCS may provide the clinician and/or clinician's staff the ability to access the personalized patient information. The DDCS can wirelessly link to a remote, centralized server for data storage, retrieval and analysis, with the transmission and storage of all patient data protected by encryption (i.e., HIPAA-compliant encryption), and the DDCS will desirably incorporate redundant backup, buffer and caching systems to ensure data integrity and security. Furthermore, the DDCS may offer the clinician and/or staff to reassign a new username and password if it is forgotten or misplaced 760.

In various embodiments, the DDCS can include a comprehensive suite of features for easy administration by any clinical practice as shown in FIG. 8. After the clinician and/or clinician's staff has accessed the software, the system desirably combines user-friendly and intuitive data entry (i.e., a “smart” or learning system) and display tools (i.e., a clinician portal 770), that can be operated with little or no specialized training or education with powerful data storage and analysis systems. The simplified user pages and modern interface design of the DDCS will desirably significantly lower the opportunity for human error in data entry, and the system is scalable for use in any size practice, hospital or other healthcare industry. For example, the clinician portal 770 may have a suite of features that include a patient search or look-up 780, today's patients being treated that day 790, custom or standardized reports 810, a data comparison tool 800, a patient portal 910 (see FIG. 11), a “my account” feature and/or any combination thereof. The suite of features may be displayed as pictorial representations, word representations, audio representations, visual representation (i.e., color, shapes or patterns) and/or a combination thereof.

Desirably, the suite of features on the clinician portal 770 or any other feature may be accessed on the PED by using a variety of input methodologies, including touchscreen technology, voice activation, and/or “hover” or “sensory” input technologies. For example, in various alternative embodiments, the device and associated software may facilitate “proximity detection” or “hover input” technology, which can detect a user's finger and/or other input device using a variety of methodologies, including detection of magnetic and/or electrical fields in a user's body and/or extremities thereof. Proximity detection would allow a user, such as a physician or other caregiver, to enter various data (and/or navigate the various systems) as described herein without requiring a physical “touch” to an input device such as a display screen and/or input device, which could reduce and/or eliminate the potential for breaking the “sterile barrier” prior to, during and/or after a surgical procedure. Furthermore, the PED may provide feedback that a feature was selected, such as vibration, verbal confirmation (by repeating the selection) or color association.

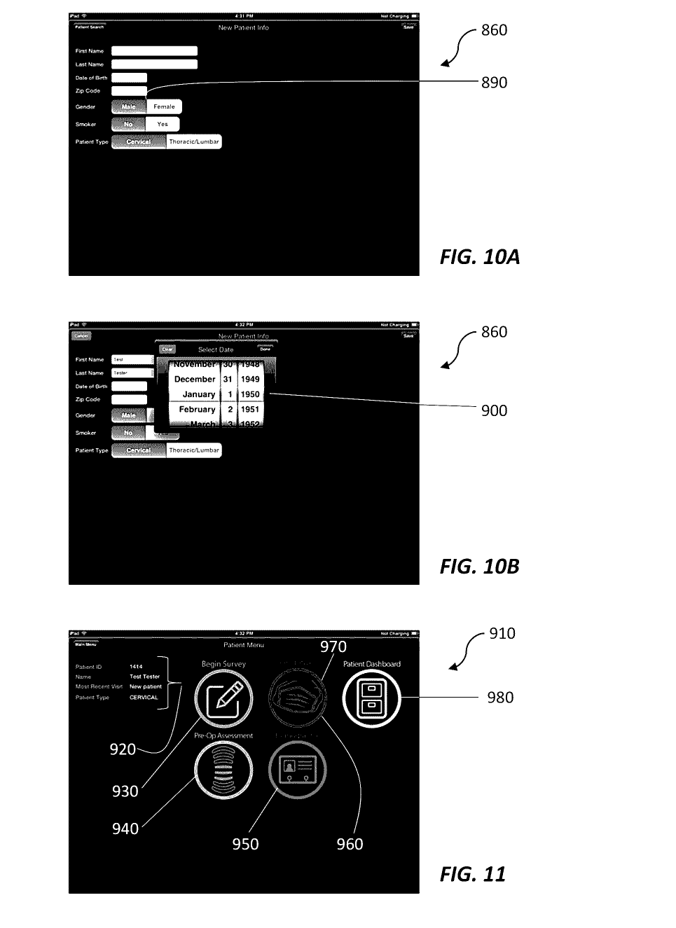

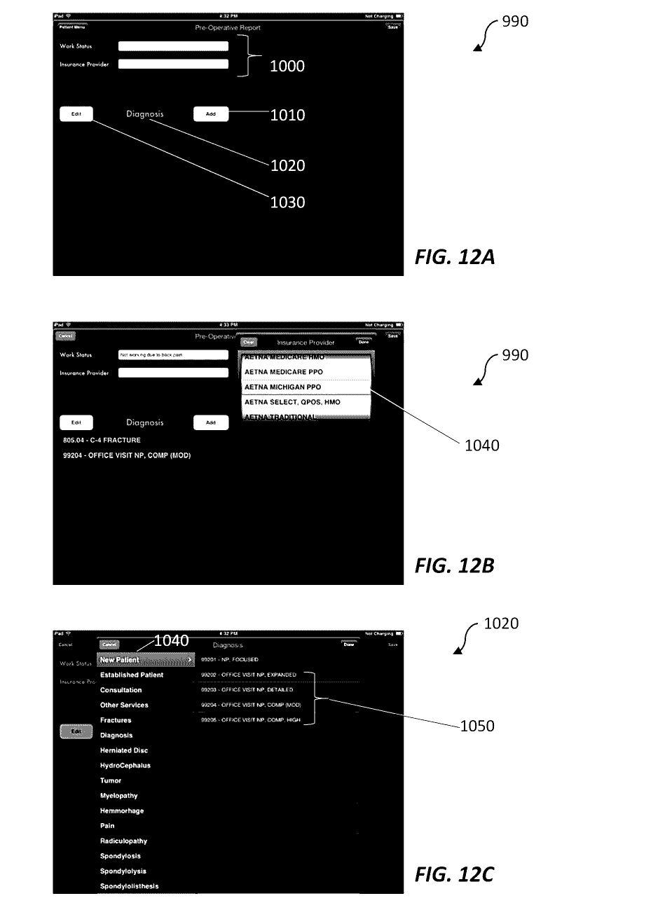

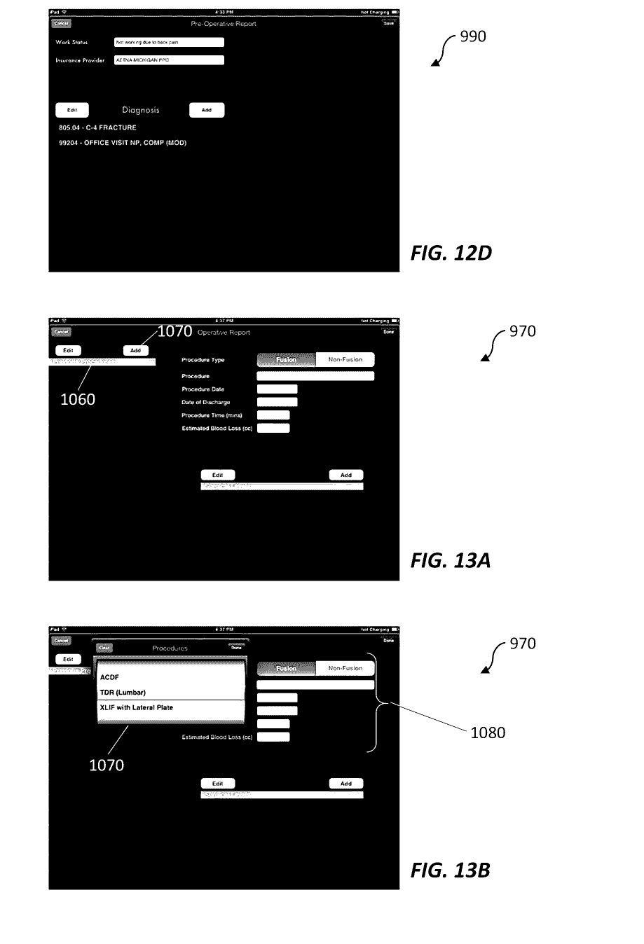

In one embodiment, if a clinician or clinician staff member requires a patient search or look up, they may use the touch screen to press a “patient look-up” 780 button. If desired, the DDCS may activate a “user feedback feature,” where the DDCS may vibrate if the button was pressed properly, or may repeat the title of the button, or a color may highlight the selection. Once the clinician and/or clinician's staff has accessed the “patient look-up” button 780, the patient look-up or search display screen 820 or the graphical user interface (GUI) 820 may display various types of information in a easy to read format. In one embodiment, the patient look-up or search GUI 820 may display the ability to enter a patient name (if it is known) 840, patient ID 850, display a list of patients 830, and or enter a new patient 860 into the DDCS software. Should entering of information be required, the clinician and/or staff may enter text information (i.e., using a keyboard), use option buttons 890 (see FIG. 10A), scroll and select 900 (see FIG. 10B), highlight and tap 1050 (see FIG. 12C), and/or any combination thereof. In addition, such listing of patients 830 may be a list, where the DDCS has cookies that tracked the most recent patients that visited, the most frequent patients that have visited, a cached list of patients for the day or previous day, and/or a combination thereof. If desired, the system may have re-defined list of patients and/or access the physician's and/or staff member's calendar to determine the likely patient identification, which may include presenting to the user one or more pre-filled fields corresponding to the patient anticipated by the system.

In various embodiments, the DDCS may include a data comparison tool 800 in the clinician portal 770, or any other accessible interface. Desirably, the data comparison tool 800 can enable a clinician to analyze data from a wide variety of data sources, including comparing data from other clinicians and/or a national database who have performed the same type of surgery or used similar implants in their surgical procedures. Such a comparison can allow a clinician to either modify the care provided to the patient, or allow the patient to make more informed decisions on the selection of his or her clinician or surgical procedure. Also, such data comparison may assist other businesses, such as insurance providers and/or medical device/drug manufacturers. The information may be used to help increase or decrease specific coverage for a specific medical device or treatment based on the performance. Alternatively, the data comparison can be used if a doctor is attempting to obtain approval for a specific procedure that may not be commonly performed, if the clinician or physician can show that the medical device or treatment is improved over the standard medical device or treatments commonly used.

In various embodiments, the DDCS may include a “my account” feature (not shown). The “my account” feature may display various aspects of the clinician and/or clinician's staff profile information, the specific financing arrangement contracted with the software developer, the accessed database servers that are available, any relevant advertising and/or advertising agreements, as well as any specific updates (i.e., a “smart” or learning system) to the DDCS software or privacy policies. Desirably, the DDCS can include one or more sources of revenue for financing the DDCS, which may be optionally displayed in the “my account” feature. For example, one embodiment of a specific financing arrangement could include a clinician licensing fee for placement and support of the DDCS on physician-supplied electronic tablets located in the clinician's office. Such fees could be on a per-clinician basis, or could be based on the number of patients serviced by the system. Another embodiment could include the accessed databases that the clinician and/or staff has paid for or has access through the DDCS. Such databases may include licensing database prospective registry access license fees, which could be assessed to physicians and/or third parties wishing to access data generated by clinicians in the future with the data used for a variety of purposes, including publication of articles, marketing of products, or clinical protocols. Another alternative embodiment for accessed database servers could include non-clinician access to the aggregated data in one or more database servers (i.e., retrospective access to data). In such embodiments, a database could contain surgical outcomes data for a wide variety of surgeries and surgical devices, which would place the owner of this data in the unique position of possessing data that could quantify virtually any surgical product's performance. Access to this database and/or analytics thereof could demand significant license fees to gather, analyze and provide quantifiable clinical data (obtained using the various systems described herein) for a variety of purposes, including the generation of clinical publications. License fees for such access could vary due to the complexity of the aggregated data requested. In various embodiments, the physicians providing surgical outcome information could “share” in some portion of the licensing fees generated from third-party use of the database and/or analytics, which could include receipt of a set fee and/or a variable fee depending upon a variety of factors, which could include the number of relevant cases from a given physician that was included in and/or relevant to the relevant database and/or analysis.

Another alternative embodiment within the “my account” feature or any other clinician portal feature could include the incorporation of electronic industry and pharmaceutical advertisements into the various system components (include data collection pages and/or report generation outputs) using a variety of methods, including banner-type ads on the surgeon portal, on patient input screens, and within industry and analytics reporting. Furthermore, other desired information that may be available can include a series of product offerings that can be selectively loaded and/or activated for an individual clinical practice, which may include additional outcome reporting and analysis features (i.e., related or other surgeries, comorbidities, study group memberships, and/or participating clinical trials), additional electronic tablet platforms, and expansion of the DDCS interface into a variety of additional healthcare specialties.

In other various embodiments, the DDCS advanced interface can incorporate a variety of other features to facilitate patient interaction with the survey and/or solely have interaction with the clinician and/or clinician's staff. For example, the DDCS may offer a “patient portal” GUI 910 (as seen in FIG. 11). In one embodiment, the patient portal GUI 910 may include the ability to access a patient-specific survey or questionnaire 930, it may display patient specific information 920, and/or a plurality of other assessment or analysis tools 940, 950, 960, and 970. The “patient portal” GUI 910 may allow the clinician complete and private access, it may allow a patient to have complete and private access, and/or it may have hybrid access to the clinician and patient, where the clinician may control what the DDCS displays, what the patient may enter and/or where the patient may enter information.

In other various embodiments, the DDCS may include a plurality of other assessment or analysis tools, such as pre-operative data 940, patient demographics 950, operative data 960, pre-operative data 970, follow-up visit data (not shown), full questionnaire response (not shown), patient dashboard and/or any combination thereof within the patient portal GUI 910 or any other interface display. Various information may be entered such as patient work status and insurance 1000, known diagnosis 1020, new diagnosis 1010, or amending diagnosis 1030 (as seen in FIGS. 12A through 14C). This information may be specifically entered by the clinician and/or clinician staff, synced and updated by the patient's electronic health record (EHR), entered by the patient, and/or a combination of methods thereof.

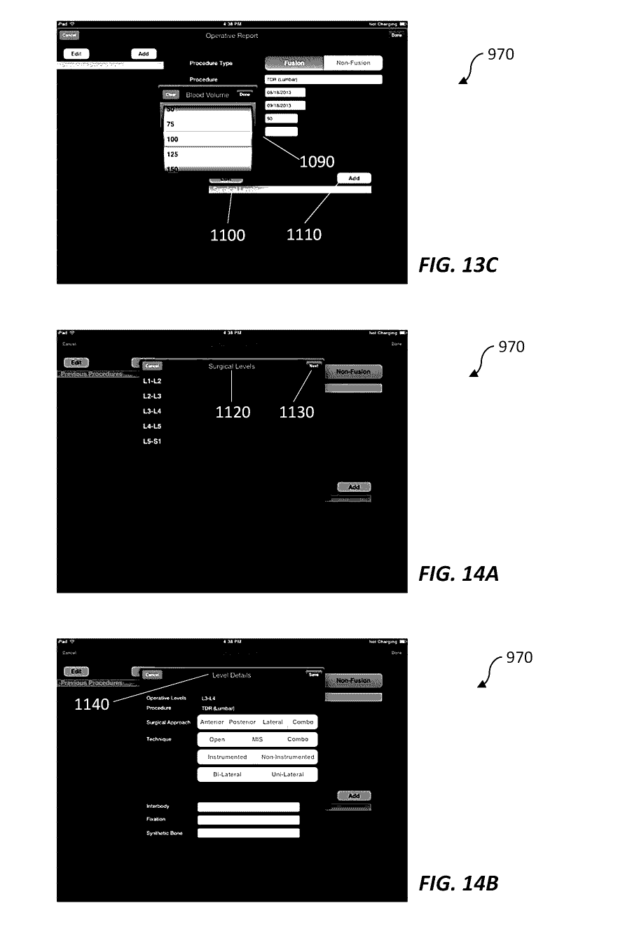

In other embodiments, clinician interfaces may be provided that also allow a physician to enter more than one device, manufacturer, treatment, access method, or additional custom equipment used during a given surgical procedure (see FIGS. 13A and 13B). For example, the patient may receive a dual total knee replacement in one surgery, but the medical device 1070, and/or other useful medical device information 1080 may be input into the system, such as identification of the manufacturer, treatment, access method, or additional custom equipment used during the procedure, which may be different for each side of the surgery. This may similarly apply if a given surgery contained different combinations of surgeries (i.e., back, knee and shoulder treatments on a single patient), as well as where multiple tool and/or device types are used in a single surgery (i.e., a femoral implant and a patellar implant from two different manufacturers used in the same knee surgery).

In various other embodiments, the DDCS may include a patient-specific survey or questionnaire 930 feature, which may be displayed in patient portal GUI 910 and/or any other interface. Desirably, clinicians/surgeons/physicians may select from a variety of validated questionnaires that are specific to a targeted portion of the body and/or medical condition(s). For example, such questionnaires that may be used for spinal surgeries may include, but not limited to: Oswestry Disability Index (ODI), Neck Disability Index (NDI), Quality of Life (QOL SF-36), Pain Disability Index (PDI), Odom's Criteria, Visual Analog Scale (VAS), and any combination(s) thereof. In addition, the surgeon may choose to slightly modify validated questionnaires (“modified-validated”), such as by changing the order in which the questions were given, eliminating a question, supplementing a question, and/or changing the question to some slight degree. Furthermore, custom questions may be specifically derived from the surgeon/physician, the software developer, and/or other third parties, which may or may not relate to the validated or modified-validated questionnaires (i.e., occupation, location of pain, etc).

In various other embodiments, the questions may be displayed after the patient has confirmed the proper patient has been identified. In FIG. 15, the survey interface 930 may display a patient identification and/or confirmation screen with limited or encrypted identifying patient information 1180 that complies with HIPAA requirements. Once the patient confirms that they are the correct patient displayed in the text (or announced by audio), then the patient may desirably press or verbally confirm that the proper patient information and the survey questionnaire shall initiate.

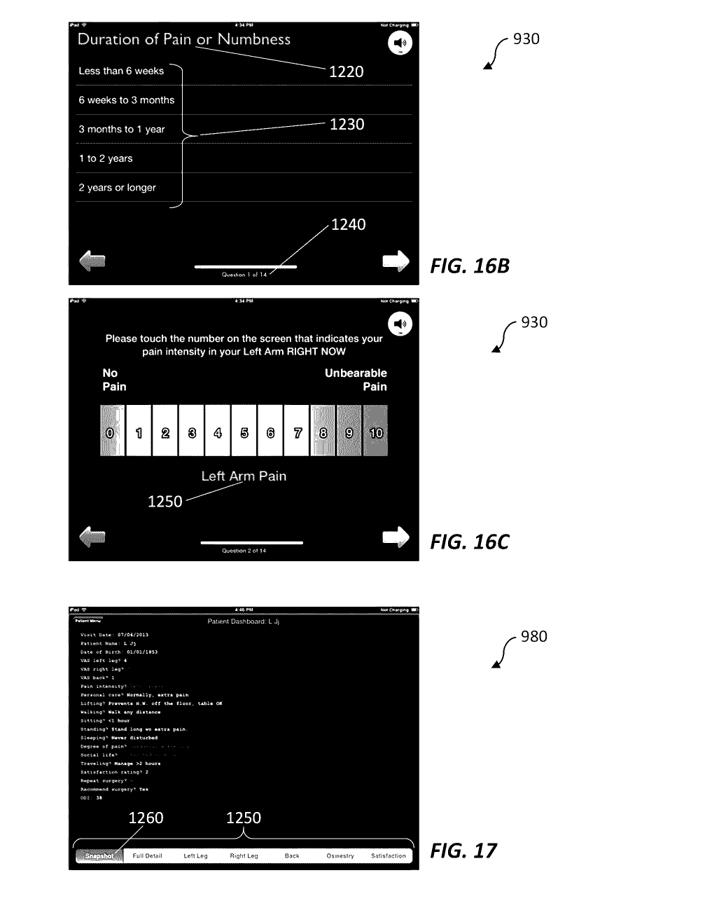

Desirably, the survey questionnaire may include advanced features tailored to patient-friendly software interfaces, instructions 1190 and user-friendly multi-lingual (not shown) and audio options 1200 as shown in FIG. 16A. Such patient-friendly software interfaces may include large text, colored text, pictorial representations (volume 1200) and/or audio text for the patient to easily understand the questions 1230, instructions 1190, titles 1220 and complete the survey (see FIGS. 16A-16C). The DDCS may offer the ability to increase or decrease the volume of the text being read by pressing the touchscreen volume button 1200 or by voice operated function. Once the question has been read and the patient has answered the question accordingly, the DDCS software may automatically or manually continue to the next question 1210. The DDCS may also offer the patient the page number or number of questions remaining 1240.

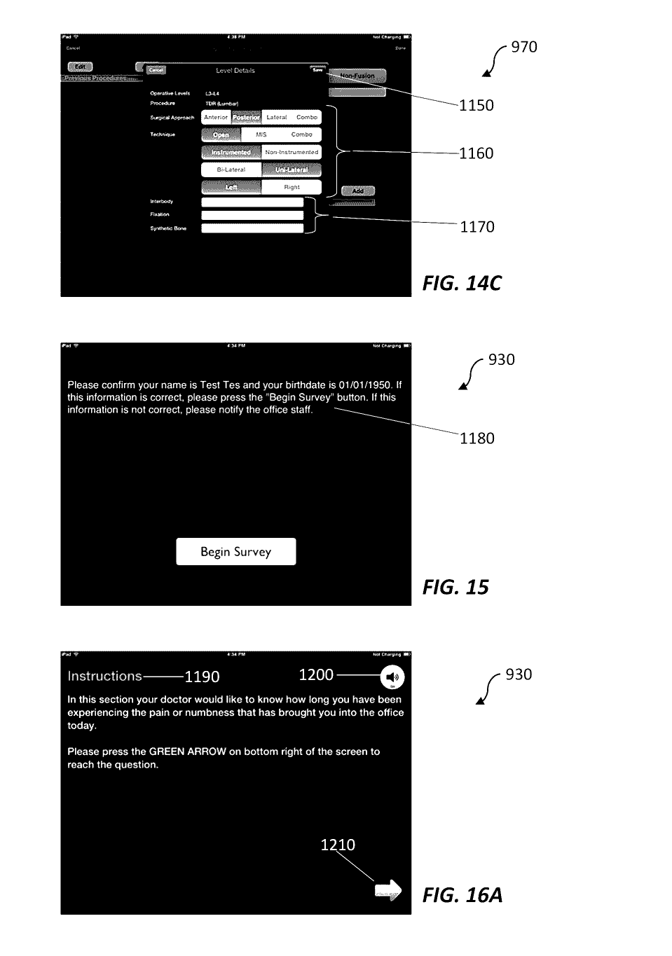

In various embodiments, clinician interfaces may include easy methods to enter data into specified fields. For example, interfaces may include drop down lists (FIG. 10B) of common treatments, medical devices, tools, additional custom equipment, the specific manufacturer, and/or any combinations thereof to select from. Also, the software developer may decide to use fields where the physician/clinician may enter custom data if the information is not available from the drop down list, including the use of slidable selectors, color selectors, and/or highlighted buttons. In addition, the software developer may incorporate easy-used indicators, including slidable selectors, colors selectors (see FIG. 16C), or a menu of highlighted buttons (see FIGS. 14B and 14C), to indicate when the physician/clinician has entered data into one or more fields.

In another exemplary embodiments, there can be a plurality of methods for storing the answers to the questions after the patient has completed the survey for real-time access, easy identification and data aggregation. The DDCS may include identification data tags in the digital data collection software that can be used to specifically identify such validated questionnaires, modified-validated and custom questionnaires (as well as individual questions therein) for easy, and immediate or future access in a data library. The software developer may design the DDCS to specifically assign the validated questionnaires, modified-validated and custom questionnaires to unique and independent modules. The type of question may be tagged as a specific module (i.e., validated, modified-validated or custom) to differentiate between the questions—with the question and its response stored in a dataset as either flat or object storage. For example, if the data are stored as objects, each object may be assigned a unique identifier which allows a server or end user to retrieve the object without needing to know the physical location of the data. This approach is useful for automating and streamlining data storage by allowing the developer to quickly and/or easily input structured queries to the data library by entering the module name and filter the questionnaire data the developer is interested in. Furthermore, object storage may be useful because it may require less metadata than traditional file systems, and allows for easy scalability. In contrast, the software developer may tag the data as flat data to allow the collection of data to be stored and accessed sequentially in a database. In either case, all data may be stored in a remote database server location with optional redundant backup servers.

In another exemplary embodiment, the DDCS may include immediate, real-time access to the recent survey questions from the treated patient to provide a “patient dashboard” summary 980. This patient dashboard summary 980 may be accessed by the clinician and/or staff to review a plurality of patient results 1250, which may include, but not limited to patient snapshot 1260, full detail of the visit (i.e., preoperative, operative, and/or follow-up visit), left leg pain, right leg pain, back pain scores, oswestry and/or satisfaction (see FIG. 17). For example, the patient snapshot 1260 may only report results from the current office visit, where the most severe or problematic answers to the questions are highlighted, to allow the clinician to review the data and make changes to the patient's treatment regimen.

If desired, the system could highlight “unusual” or “aberrant” answers and/or data entries that does not typically conform to historical data and/or that are inconsistent with other answers provided by the patient on the survey. This information could be provided to the physician and/or office personnel to allow them to verify that responses were intended by the patient and/of if they needed corrections. If desired, the system could utilize pre-existing clinical trial criteria information to determine if an given answer met various inclusion/exclusion criteria for a given drug and/or device trial, allowing the physician to verify that the correct information has been entered, that the patient truly fits or does not fit a given set of FDA criteria, and/or avoiding the need for a later correction of an incorrect data entry during third-party data collection and verification.

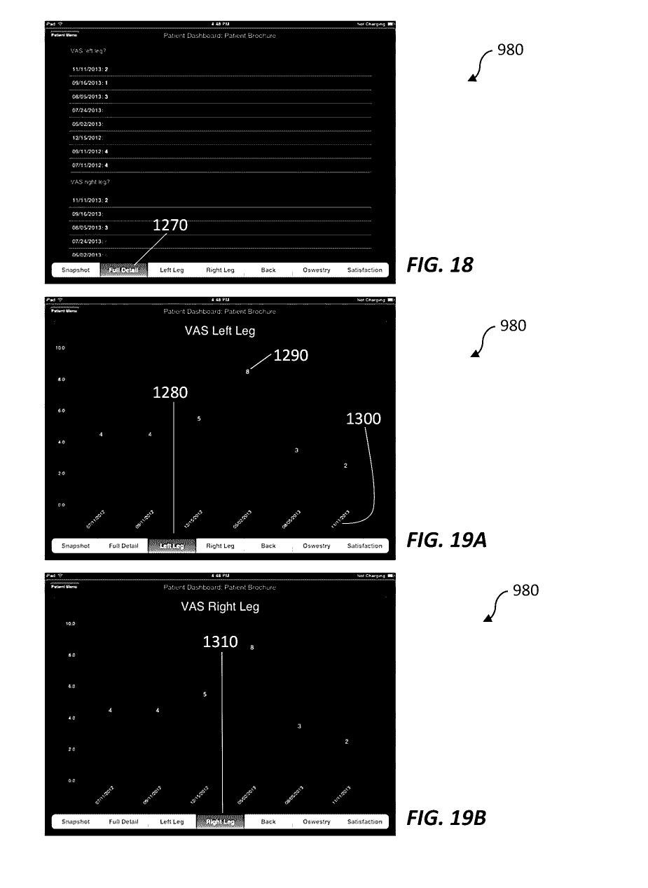

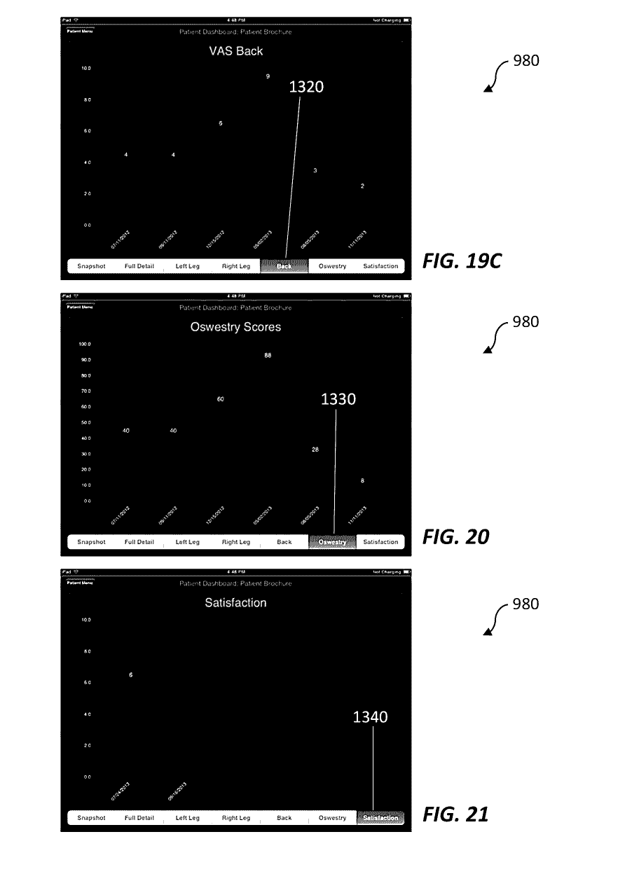

Furthermore, in FIG. 18, the DDCS may also provide for a full detail 1270 of the current and historical data from various office visits in text or graphical form. One embodiment of the DDCS may textually list the office visit date and total answered questions with severe or problematic pain. The clinician and/or staff may have real-time access to select the proper office visit with the number of problematic or most severe answers to the questions highlighted. For example, the full detail 1270 may list out a plurality of office visit dates. The office visit dates may have colored text highlighting the number of questions where the patient had indicated that the pain was problematic or most severe. The clinician and/or staff can understand pain patterns and identify where, in various consecutive visits, the patients' pain has increased and/or the patient has problematic pain or most severe pain. The clinician and/or staff can use the information to alter the patient's treatment regimen or begin to discuss surgery options. Alternatively, the patient results may be viewed graphically as seen in FIGS. 19A-19C, 20 and 21. The graphical representation may be viewed in any form known or recognized in the industry (i.e., bar graphs, line graphs, pie charts, etc.).

In other various embodiments, the DDCS may utilize the pre-identified validated, modified-validated and/or custom questions in the database in a variety of ways to further commercialize the data. The tagging or identification process of the questions may allow the software developer to quickly retrieve specific requested data by using structured queries. The structured queries may represent data that is a subset of a sample size of various patients of one or more physicians for data analysis and outcome reporting. Such data may be sold, shared, or contributed for prospective registries, diagnosis based registries, benchmarking/quantifying surgeon performance registries, complication rate registries, and various combinations thereof. The data may be analyzed by the software developer, the physician/surgeon, the clinical practice, health insurance agencies, hospitals, government, patient education, and/or other combinations thereof.

In various embodiments, the DDCS includes a simple, interactive digital data collection system that facilitates daily use of patient data by clinicians, as well as enabling powerful data mining and effective outcome reporting for patients, physicians, hospitals, device manufacturers and insurers. A simplified and user-friendly approach to data collection and aggregation is included at the heart of the system. The patient-focused query system provides innovative dynamic interaction with participants, and can be a powerful tool to remove barriers to participation at all ages and levels of education or ability. Moreover, the system can allow unprecedented levels of sophisticated real-time analysis, and can establish an infrastructure to enable physicians and hospitals to translate data into immediately useful information to improve the standard of care.

Surgeon/Clinician/Physician 3D Virtual Anatomical Model Interfaces

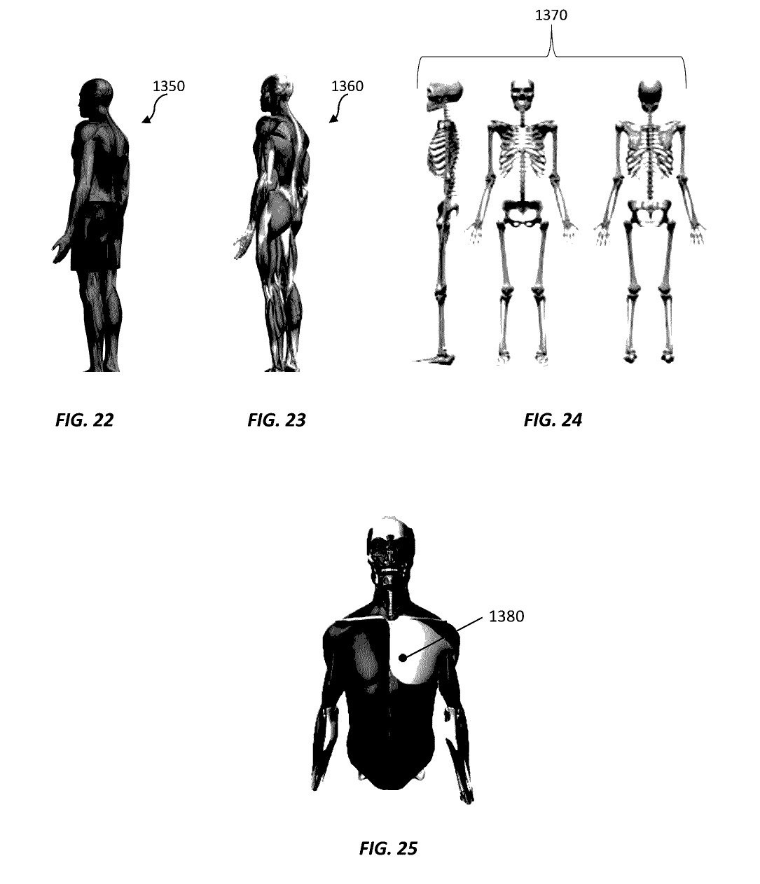

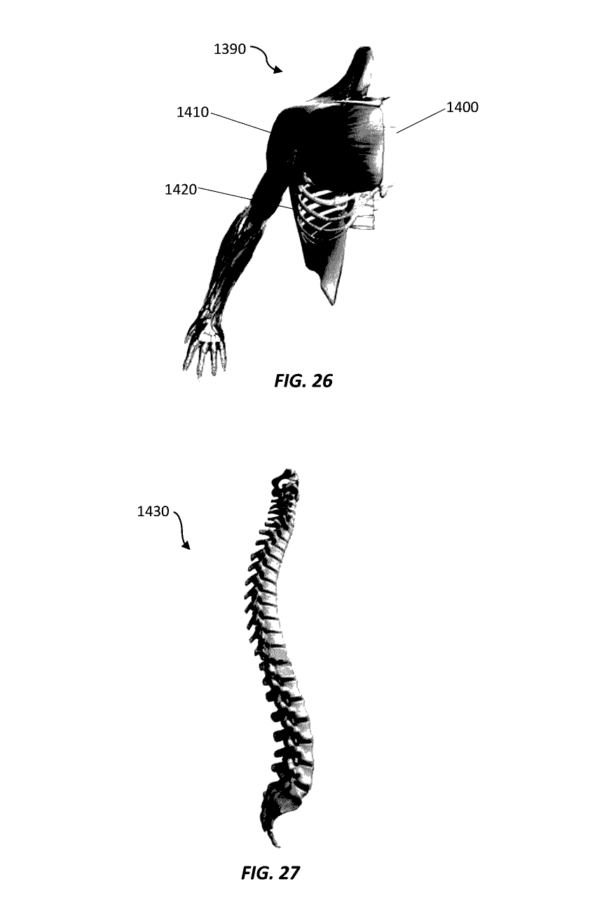

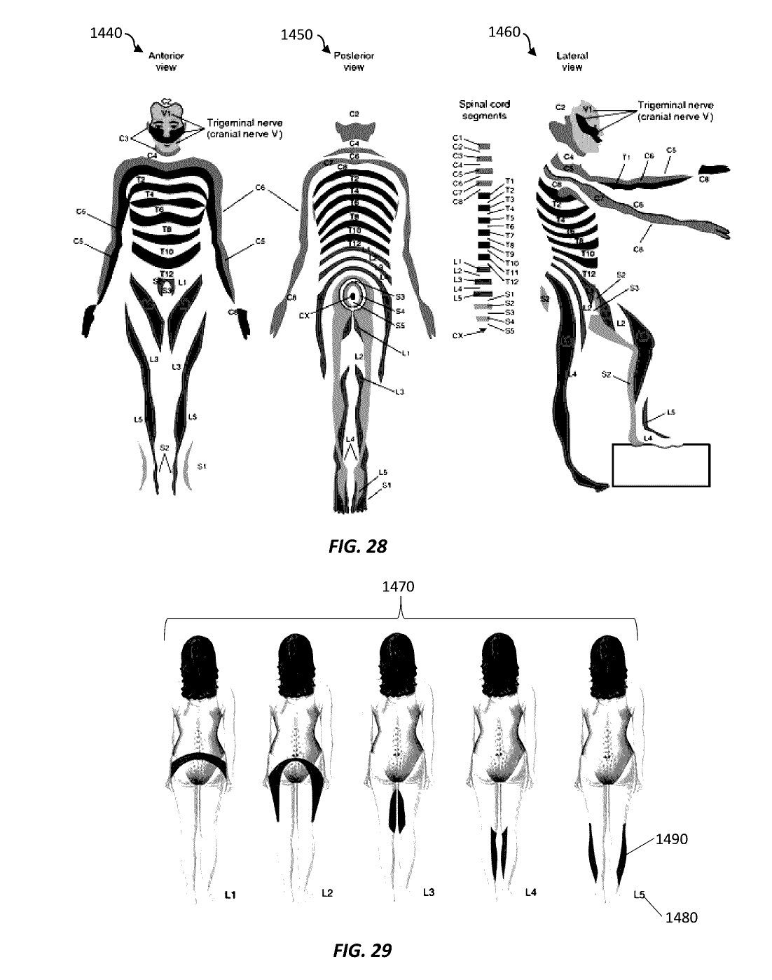

In other exemplary embodiments, the DDCS system may be optionally designed to allow a physician/clinician to input pre-operative, operative and/or post-operative patient data using at least one three-dimensional (3D) virtual model of the entire body 1350 (see FIG. 22) or portions thereof, including the musculature of the body 1360 (see FIG. 23), the skeletal system 1370 (see FIG. 24), selected areas of the body 1380 and 1390 (see FIGS. 25 and 26) and/or specific areas of the body pertinent to specific surgical specialties and/or procedures, including cardiac (not shown), pulmonary (not shown), spine 1430 (see FIG. 27), knees (not shown), shoulders (not shown), hips (not shown), and/or various combinations thereof.

In one exemplary embodiment, a surgeon may be presented with an electronic display (or GUI) depicting a generic or patient-specific 3D virtual anatomical image and/or model. The software developer may provide the physician/clinician with a feature option within the DDCS that uses a generic 3D virtual anatomical image and/or a model that may be gender specific (i.e., male or female, such as depicted in FIGS. 22 and 29). The generic 3D virtual anatomical images may be derived from average patient demographics and health, and may not capture patient specific differences in the anatomy, if desired. Alternatively, the software developer may provide the physician/clinician with another feature option within the DDCS that uses a patient-specific 3D virtual anatomical image and/or model (not shown). The software developer may request from the physician/clinician a series of various 2D or 3D images and/or data sets, including patient-specific imaging data as well as data from various clinical datasets known in the art) and design a patient-specific 3D anatomical model representative of the patient's anatomy. The 3D anatomical model may accurately depict the patient-specific degeneration, health, previous implants or prosthetics, and/or deformities. These patient-specific images may be collected and stored to establish a patient-specific anatomical image database library.

The 3D virtual model may be manipulated by the physician/clinician to identify the targeted area of the body, the treatment modality, the implants used, the surgical tools used, the lot numbers of the implants and tools, the orientation of the implants/tools used, complications, and various other component hardware or procedural steps that were planned pre-operatively and that actually occurred operatively (if desired) for comparative purposes. Furthermore, the data inputted may be collected and stored to establish an operative database library. Surgeon input may be accomplished using touch-screen technology, voice-control, proximity technology (i.e., non-touch or “hover” screen features) and/or the use of pen, mouse, trackball and/or keyboard inputs, or various combinations thereof.

In various other embodiments, the DDCS may include 3D anatomical image features that will help facilitate entering, sharing and storing information. The DDCS may include an option for highlighting, shading and/or tagging an entire body, portions of the body, and/or segments of the body 1380 (see FIG. 25). This might allow the surgeon to dissect, zoom/magnify, and/or hide the highlighted, shaded and/or tagged portions of the body or entire body. For example, the physician clinician may select the entire body 1350 (FIG. 22) and desirably “hide” the skin to show the musculature of the anatomy 1360 (see FIG. 23). This may allow the physician/clinician to point out the nature and location of the patient's pain and/or differentiate between radicular, neurologic and/or orthopedic pain. Furthermore, the physician/clinician may further deselect the musculature in FIG. 23 to the skeletal system 1370 in FIG. 24. In addition, the physician/clinician may desirably want to depict various sectional views that may involve a combination of skin 1400, musculature 1410 and/or skeletal system 1420 simultaneously as depicted in FIG. 26, and/or sectional views that may be rotated to see side, top, bottom, and/or isometric views (not shown).

In using the various features of the system, the physician/clinician may decide to highlight, shade, tag, hide, dissect and/or zoom/magnify by using the touch screen on any iPad or other portable electronic device, as well as using and/or designing a drop down menu, using “saved favorites,” (i.e., a “smart” or learning system) a drop down menu with commonly selected body segments, and/or custom entries. The physician/surgeon may use his or her finger on a touch screen by drawing a box, dragging, using one or more finger taps to highlight, shade, tag, hide, dissect and/or zoom/magnify, and/or a combination thereof. Various image manipulations features and effects, which may be similar to design manipulation features commonly used by engineers/designers in 3D computer aided design (CAD) programs, can be provided to the physician/clinician as part of the DDCS.

In other various embodiments, the DDCS may include features that allow the physician/clinician to rotate the 3D anatomical image in any direction (see FIGS. 24 and 28), annotate, “share” information to 3^{rd} parties, the patient, and/or the physician/clinician, and/or add specific “favorites” (i.e., a “smart” or learning system) that may be recalled at a later visit (not shown).

In other various embodiments, the DDCS may include features that allow the physician/clinician to utilize 3D anatomical images that contain dermatome maps. FIGS. 28-30 depict various examples of 3D anatomical images that may be used as dermatome maps. For example, FIG. 28 may provide various 3D anatomical images that may already trace the specific spine segment in which a patient may feel pain, tingling, numbness and/or hypersensitivity. The 3D virtual images may be presented with anterior 1440, posterior 1450, right and left views 1460 (i.e., lateral view) of a 3D model to allow the physician/clinician (or patient, if desired) to draw a box, dragging, highlight, shade, tag, hide, dissect and/or zoom/magnify, and/or a combination thereof around the indicated pain, and display the targeted spine segment in which treatment or surgery may be necessary. All information can be stored in a targeted spine segment and/or dermatome library database for outcome reporting, further access, and/or further analysis.

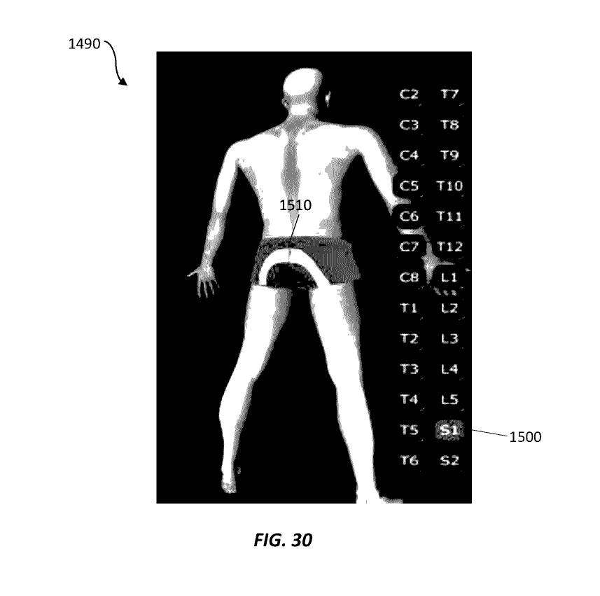

Alternatively, in another embodiment, the physician/clinician and/or patient may also be presented with at least one 3D virtual anatomical model that highlights the location of a patient feeling pain, tingling, spasms, numbness and/or hypersensitivity on the skin, limbs or any location on the body 1470 as shown in FIG. 29. The highlighted areas that the patient may experience pain, tingling, spasms, numbness and/or hypersensitivity can correlate to the spine segment 1480 that may require surgery or surgical inspection (i.e., like a dermatome map). The physician/clinician and/or patient can draw a box, dragging, highlight, shade 1490, tag, hide, dissect and/or zoom/magnify, and/or a combination thereof around the indicated pain, and display the targeted spine segment in which treatment or surgery may be necessary. All information can be stored in a targeted spine segment and/or dermatome library database for outcome reporting, further access, and/or further analysis. In addition, FIG. 30 may allow the physician/clinician to be presented with at least one virtual 3D anatomical model that contains a list of the targeted spine segment 1490. The physician/clinician may press the specific targeted spine segment 1500 (i.e., S1, C2 or C3), and the 3D virtual anatomical model will display and/or highlight 1510 the common areas of pain, tingling, numbness and/or hypersensitivity. All information can be stored in a targeted spine segment and/or dermatome library database for outcome reporting, further access, and/or further analysis.

Prepopulated and/or Standardized Report Modules

In various other embodiments, the DDCS may include optional prepopulated and/or standardized report modules for the clinician and/or staff access. Such prepopulated and/or standardized reports may include reports relating to pre-operative visits, operative procedure, and/or post-operative follow-up visits. The physician/clinician may enter various information related to pre-operative visits, operative procedure, and/or post-operative follow-up that may result in the creation of prepopulated and/or standardized report modules. For example, in one embodiment, the physician/clinician may desirably enter various patient information manually, may sync to the patients' electronic health record, and/or may select and/or highlight the proposed segmented portion of the body on a 3D virtual anatomical image during the pre-operative and/or operative visit where the patient may feel pain and/or where the patient may have the desired surgery. If the physician/clinician chooses to enter information on a 3D virtual anatomical image, such information may be entered by the physician using his fingers to highlight, shade, tag, hide, dissect, and/or zoom/magnify on the touch screen on any iPad or other portable electronic device. A drop down menu with commonly selected body segments, previously recalled “saved favorites,” (i.e., a “smart” or learning system) and/or custom entries may be used may be shown and/or recalled for the doctor to enter implant size, implant lot number, the implant manufacturer, complications, date, performing surgeon, electronic or standard signature, and/or any custom entries. This operative information may be stored in a pre-operative (pre-operative module) and/or operative database library (the operative module) for immediate or future access of the stored data. Using the previously entered pre-operative and/or operative data, the DDCS may optionally include an additional feature that allows the physician/clinician to generate a standardized pre-operative and/or operative report with pre-printed or prepopulated operative paragraphs that incorporates all of the pre-operative and/or operative information previously entered for printing, sharing and/or storing with the hospital, the physician/clinician, the patient's electronic health record and/or any combinations thereof. Alternatively, the prepopulated and/or standardized pre-operative and/or operative reports may generated from the patients' medical history, medical chart and/or electronic health record.

Furthermore, standard pre-operative and post-operative follow-up visit reports may be generated using the prepopulated and/or pre-printed paragraphs with the stored pre-operative and/or post-operative visit data entered by the physician/clinician using the patient's medical history, medical chart, electronic health record and/or 3D virtual model. Such prepopulated and/or standardized reports may be used for all types of visits, which may include preoperative, operative, and post-operative follow-up visits. Also, these reports may assist with improving workflow efficiency, consistency of reports, reduction of missing information, and quick access to summarized data.

Insurance Authorization Module (Insurance Payor Hosted)

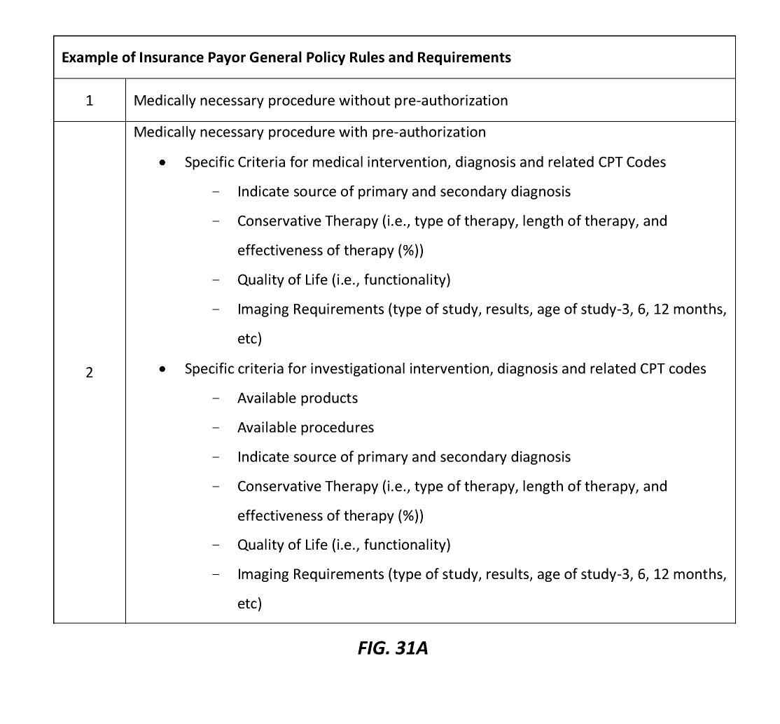

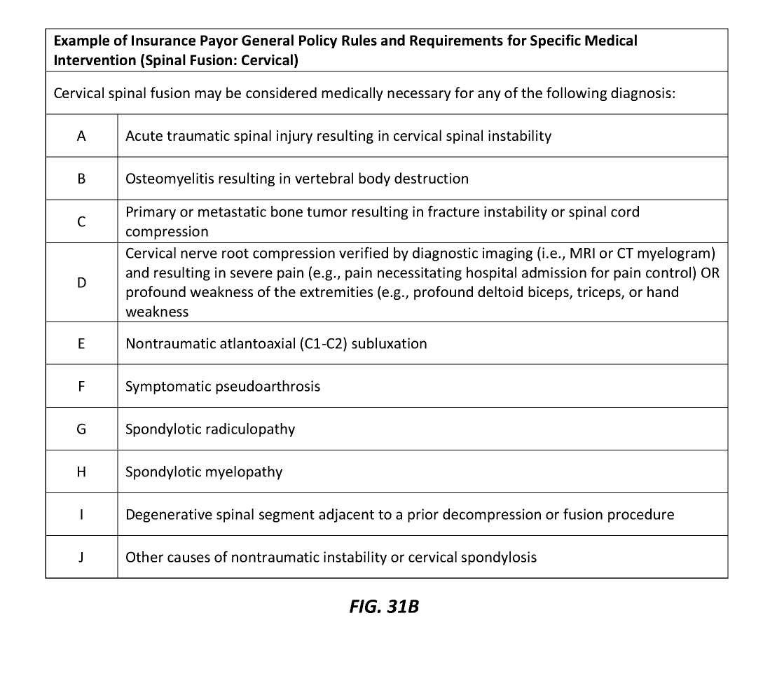

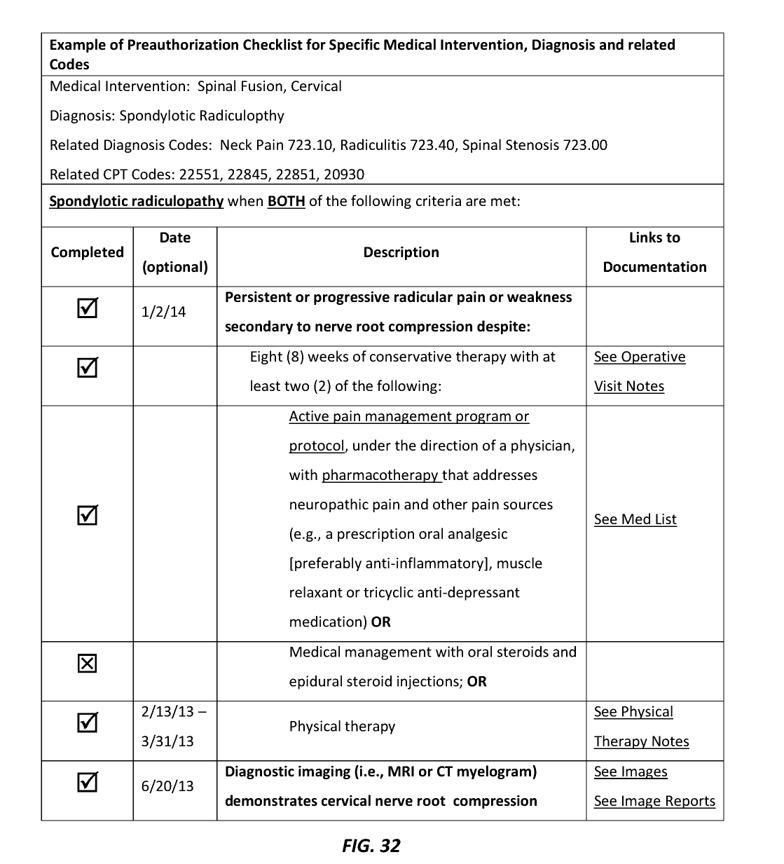

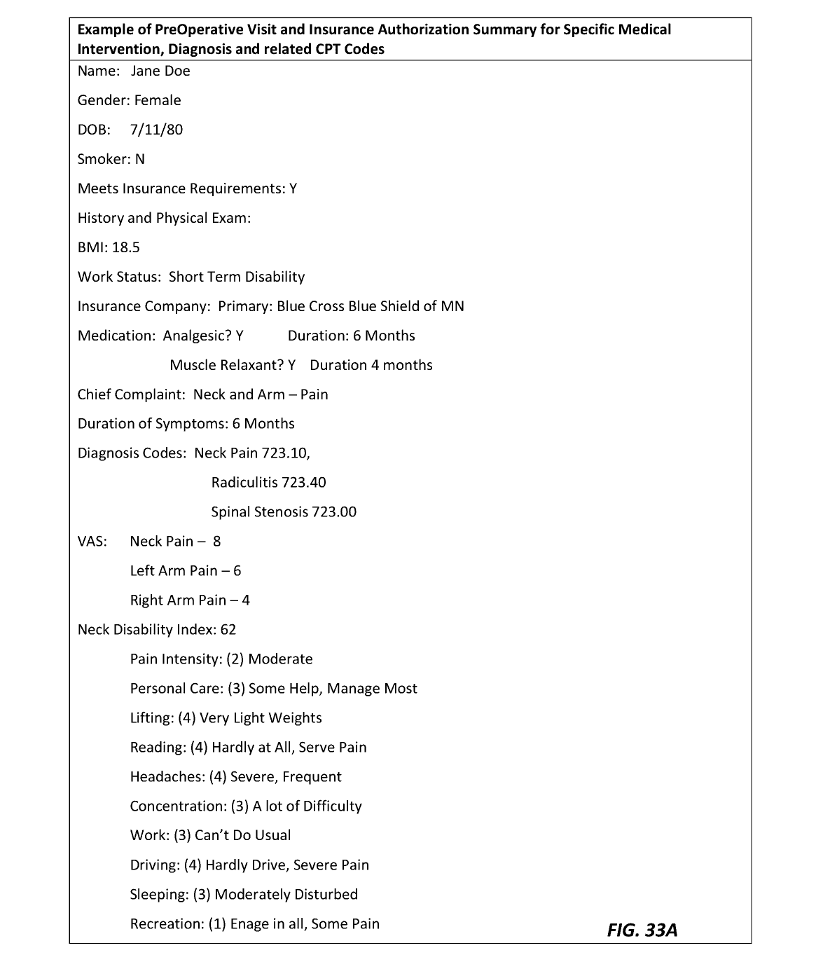

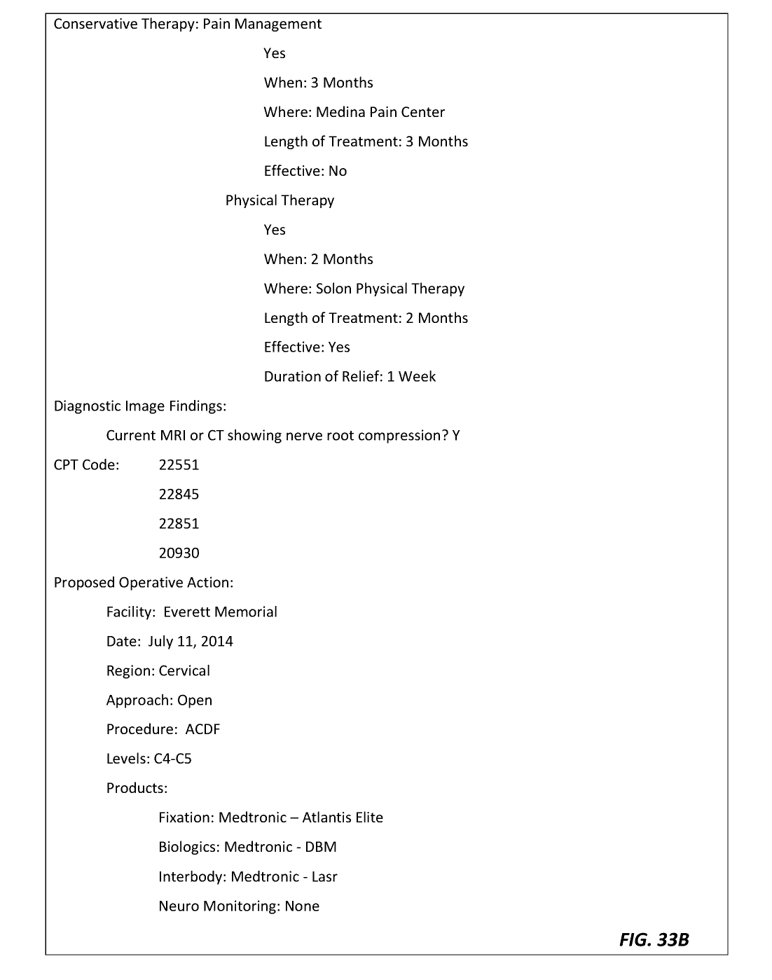

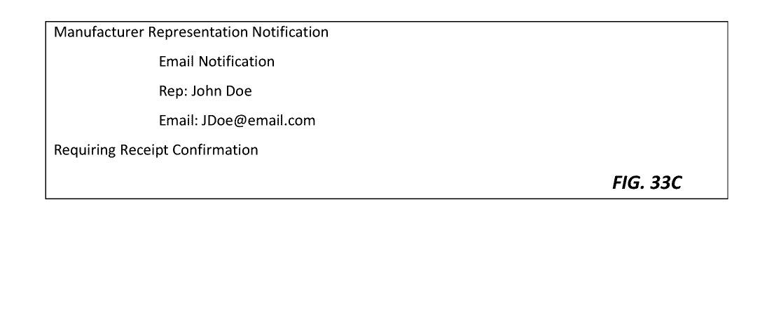

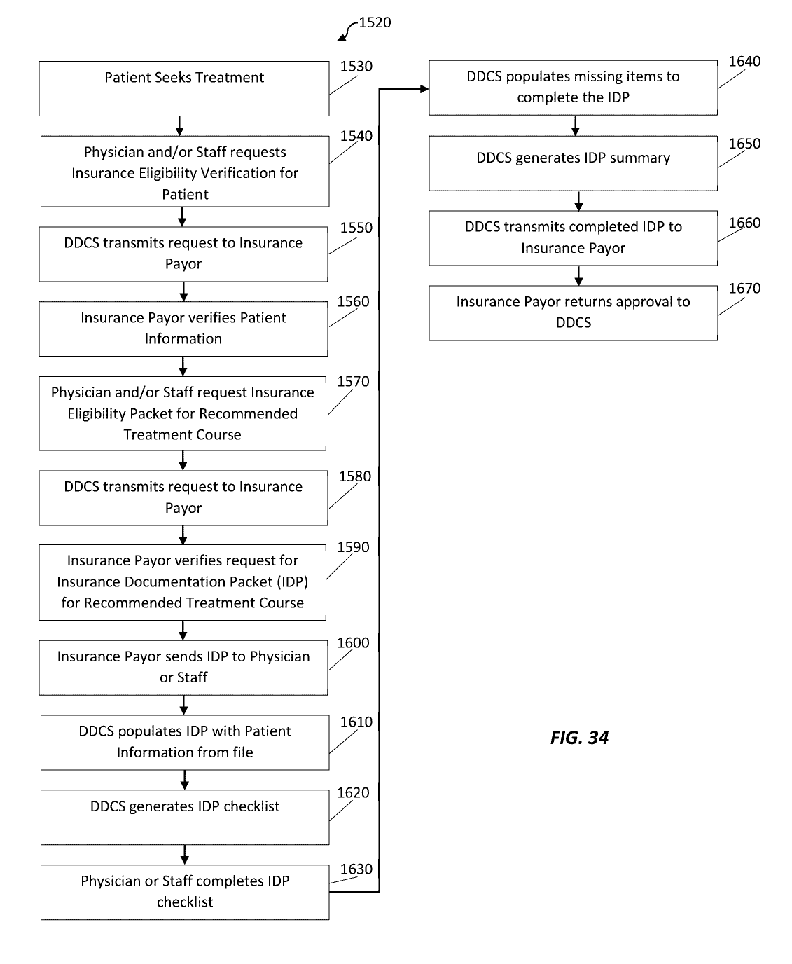

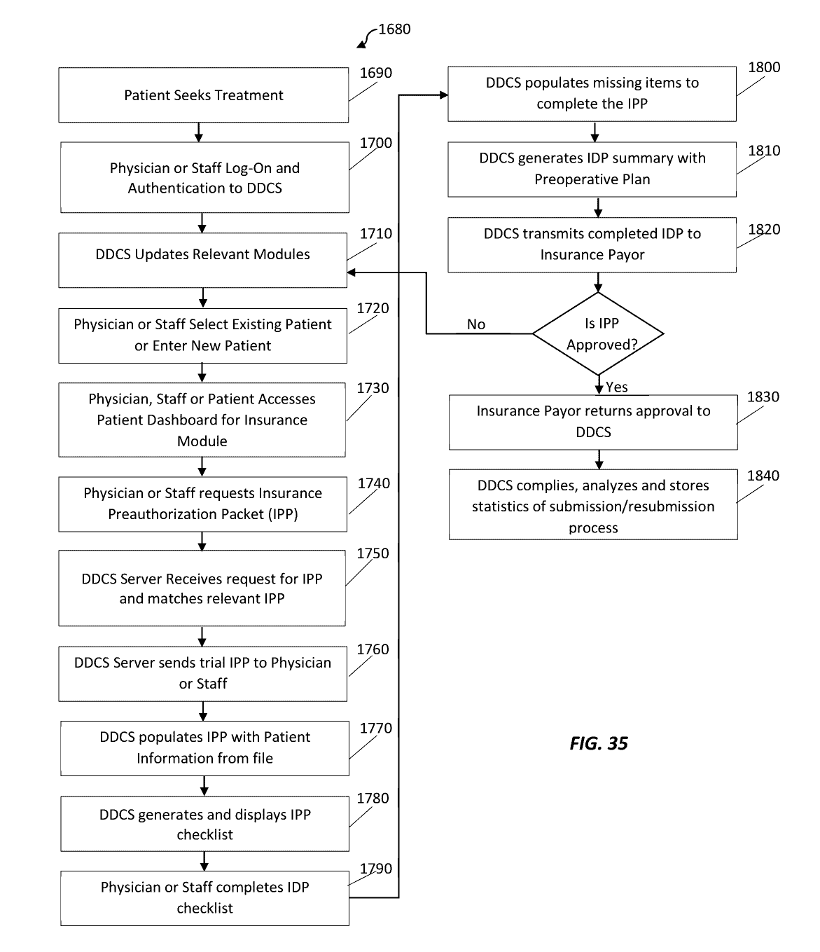

In various other embodiments, the DDCS may include an optional insurance payor hosted insurance authorization module 1520, such as shown in FIG. 34. An insurance payor hosted authorization module may be designed to use the pre-operative data visit (or any other relevant office visit) information entered by the physician/clinician to generate prepopulated and/or standardized documentation required for authorization of payment of recommended medical interventions by each patient insurance policy. The insurance authorization prepopulated and/or standardized documentation and/or packet may include insurance policy documentation (see FIG. 31A), required insurance diagnosis (see FIG. 31B), required authorization forms (not shown), preauthorization checklist (see FIG. 32) (and/or post-surgical authorization checklist) for each patient and/or preauthorization summary (see FIGS. 33A-33C) to improve workflow efficiency and increase the frequency of procedure approvals by the insurance payor.

In one embodiment, the insurance authorization module 1520 (see FIG. 34) may allow the physician/clinician and/or practice to determine whether a recommended medical intervention is authorized by a specific patients' personal medical insurance policy. The insurance authorization module may comprise a patient seeking treatment 1530, entering the proper insurance payor information from one or more visits 1540, DDCS transmitting proper information to Insurance payor 1550, verifying that the proper insurance payor information has been entered 1560; recommending and entering a medical intervention, diagnosis and related codes (CPT and/or diagnosis) 1570; DDCS transmits proper medical intervention, diagnosis and related codes to Insurance payor 1580, verify whether the medical intervention, diagnosis and related CPT codes has been entered properly 1590; recall the specific rules and requirements of the recommended medical intervention, diagnosis and related codes (CPT and/or diagnosis) from the specific insurance payor; recall and/or verify the required forms used by the specific insurance payor for the recommended medical intervention, diagnosis and related codes (CPT and/or diagnosis) 1600; DDCS populates required forms for recommended intervention, diagnosis and related codes 1610, including the optional display of any insurance authorization checklist and/or any required forms for the recommended medical intervention diagnosis and related codes (CPT and/or diagnosis) 1620; physician and/or staff “fills in” and/or otherwise completes any missing information from the insurance authorization checklist 1630, which may include recalling information from one or more previous visits from the relevant visit database to prepopulate the insurance authorization checklist and required forms with completed information from one or more previous visits 1640; display updated insurance authorization checklist and required forms with completed information from one or more previous operative visits 1640; notify and/or display to physician/clinician any missing information and/or unacceptable entries from the insurance authorization checklist and required forms; send, share, store, and/or print completed insurance authorization checklist, required forms, test results, images, and/or letters to patient electronic health record, hospital, physician/clinician, insurance payor, clinical practice and/or any 3rd party; recall one or more previous visits from the relevant visit database to prepopulate the insurance authorization summary with completed information from one or more previous operative visits 1650; and/or display updated preoperative visit and insurance authorization summary with completed information from one or more previous operative visits; transmit completed insurance authorization document 1660, and receive approval from Insurance payor 1670.

In one exemplary embodiment, a patient may have undergone a plurality of pre-operative visits in an attempt to diagnose and/or treat his severe back pain condition. The physician/clinician has treated the patient accordingly by completing standard pain assessment techniques, ordered various lab tests and imaging, and has entered the proper insurance payor information in the DDCS (i.e., Blue Cross Blue Shield of MN), where all of the information may be stored in the DDCS operative database. The physician/clinician and/or staff logs onto the DDCS, where the DDCS will authenticate the log-in information and download and/or cache any updated information required for the software and the respective patient(s). The physician/clinician may select the proper patient to access the specific patient modules and/or the insurance payor hosted authorization insurance module. Once the physician/clinician enters the insurance payor hosted authorization insurance module on the DDCS display screen, the DDCS may prompt the physician to enter the recommended medical intervention (i.e. cervical spinal fusion), diagnosis (i.e., spondylotic radiculopathy), related diagnosis codes (i.e., Neck pain 723.10, radiculitis 723.40, and spinal stenosis 723.00) and/or related CPT codes (i.e., 22551, 22845, 22851, 20930) using a drop down list, “saved favorites,” (i.e., a “smart” or learning system) and/or manual entry. The DDCS may contact Blue Cross Blue Shield (BCBS) (i.e., the insurance payor and/or third-party that will be hosting the insurance eligibility or documentation packet) of MN database and/or contact software developer remote database (or other appropriate information source) to obtain the current insurance authorization information, to obtain any updated insurance authorization information (i.e., whether an approval process has changed since last update) and/or to verify whether the medical intervention, diagnosis and related CPT codes has been entered properly. If the information was entered properly, the DDCS can recall and/or display the specific rules and requirements (see FIGS. 31A and 31B) and/or required forms (not shown) used by BCBS of MN for the recommended medical intervention, diagnosis and related CPT codes. If the medical intervention, diagnosis and related CPT codes have not been entered properly, the DDCS may notify the physician/clinician to reenter the proper information (i.e., audible signal, text warning boxes, highlighted areas, etc). The DDCS may optionally generate and display an insurance authorization checklist (see FIG. 32A) and/or any required forms (not shown) for the recommended medical intervention diagnosis and related CPT codes as required by BCBS of MN. The DDCS may subsequently recall one or more previous operative visits from the specific patient's operative visit database (and/or the DDCS may reference information from another patient's database who recently received a successful authorization from the same insurance company for the same or similar surgery) to prepopulate the insurance authorization checklist and required forms with any completed information from one or more previous operative visits. The DDCS can update and display updated insurance authorization checklist and required forms with completed information from one or more previous operative visits (see FIG. 32B). The DDCS can notify and/or display to physician/clinician any missing information from the insurance authorization checklist and required forms by audible signal, text warning boxes, highlighted areas, etc. If missing, incomplete and/or incorrect information cannot be obtained (and/or relevant entries “amended” to correct such deficiencies), the physician/clinician may have to continue seeing the patient with one or more additional pre-operative visits and/or order subsequent tests until the proper information is available/completed. However, if the proper information from the insurance authorization checklist and required forms are completed, the physician/clinician may send, share, store, link and/or print completed insurance authorization checklist, required forms, test results, images, and/or letters to patient electronic health record, hospital, physician/clinician, insurance payor, clinical practice and/or any 3rd party. The insurance payor may quickly review the completed insurance authorization checklist, required forms and required data (i.e., by accessing the links or having hard copies of documentation), which may include payor review using fully and/or partially automated review systems, to approve and/or authorize the medical intervention.

In another exemplary embodiment, the DDCS may also generate and/or display an insurance authorization summary for the specific medical intervention, diagnosis and/or related CPT codes (see FIGS. 33A-33C). The insurance authorization summary may organize information from a plurality of previous visits for submission of the insurance authorization documentation packet to the insurance payor. Such information that may be included may be derived from the policy rules and requirements for a specific recommended medical intervention and required diagnosis. The information may comprise patient demographics, patient work status, medications, duration of pain and/or symptoms, CPT codes, questionnaire answers and/or frequency of pain, pain management or therapies, diagnostic image finding results, proposed surgery information, manufacturer representation information, and/or any combination thereof. The DDCS may review the insurance payor policy rules and requirements and review the patient electronic health record (EHR). The DDCS may use the information retrieved from the patient EHR and populate a standard summary form for the specific recommended medical intervention. This standard summary form may be transmitted with the insurance documentation packet and be used to acquire approval from the insurance payor.

In another exemplary embodiment, the insurance payor may transmit the approval of the recommended course of treatment through one of the plurality of DDCS interfaces (i.e., clinician portal and/or patient portal). After the DDCS transmits the completed insurance documentation packet to the insurance payor, the insurance payor database or processor may confirm/verify that all requirements have been met, then the insurance payor may forward an automatic preliminary notice of approval to the DDCS. This preliminary notice of approval may be delivered to any one of the plurality of DDCS interfaces where the physician and/or staff may access the notice of approval. The notice of approval may be provided in hyperlink, where the physician and/or staff may click on the hyperlink to retrieve the formal notice of approval in writing. The notice of approval in writing may be forwarded, shared and/or stored to the patient EHR. Alternatively, the notice of approval may be sent with a clickable icon that displays the formal notice of approval from the insurance payor.

Insurance Authorization Module (DDCS Hosted)

In an alternative embodiment, the DDCS may include an optional DDCS hosted insurance authorization module, where the physician/clinician may generate prepopulated and/or standardized insurance authorization documentation for payment of recommended medical interventions by each patient insurance policy. The DDCS may host a remote server that contains a plurality of prepopulated and/or standardized insurance eligibility forms or packets, including the type of insurance, insurance policy documentation (see FIG. 31A), required insurance diagnosis (see FIG. 31B), required authorization forms (not shown), preauthorization checklists (see FIG. 32) (and/or post-surgical authorization checklist) for each patient, preauthorization summary (see FIGS. 33A-33C), chief concerns list (not shown) and/or preoperative plan (see FIG. 33B) to improve workflow efficiency and increase the frequency of procedure approvals by the insurance payor.

In one embodiment, the DDCS hosted insurance authorization module may allow the physician/clinician and/or patient to determine whether a recommended medical intervention is authorized by a specific patients' personal medical insurance policy. The DDCS hosted insurance authorization module may comprise development of a DDCS hosted remote server with a list of preauthorization criteria for a plurality of major insurers and policies that the physician/clinician and/or staff may request and the DDCS remote server can match the relevant preauthorization packet. The DDCS remote server can forward the matched preauthorization packet and display the proper criteria. The physician and/or staff can make efforts to complete any missing items from the matched preauthorization packet to prepare for final submission to the insurance payor. Once the matched preauthorization packet is completed, the DDCS can submit to the proper insurance payor and await approval. If approved, the insurance payor can return immediate notification of approval through the DDCS insurance module interface. However, if denied, the insurance payor may return the matched preauthorization packet with flags, highlights, comments or notes. The progress of the request and/or submission process may be tracked by the physician/clinician, staff and/or patient. The statistics of the submission/resubmission can be compiled for later review by the physician and/or staff to help determine the efficacy of their internal procedures and record keeping.

More desirably, FIG. 34 illustrates one embodiment of a DDCS hosted insurance authorization module 1680 that may comprise a patient seeking treatment 1690; physician/clinician or staff can log-on and complete authentication to the DDCS 1700; DDCS automatically updates relevant modules (i.e., a “smart” or learning system) according to methods described herein (including existing patient list, patient's treated for the day, insurance module, questionnaires, and/or combination thereof) 1710; physician/clinician and/or staff select existing patient or enter new patient information 1720; physician/clinician, staff and/or patient access patient dashboard interface (or any other relevant interface) to enter the Insurance Module 1730; physician/clinician and/or staff requests insurance preauthorization packet (IPP) 1740; DDCS server receives request for IPP and matches relevant IPP 1750; DDCS server sends trial IPP to physician/staff DDCS interface 1760; DDCS populates required IPP for recommended intervention, diagnosis and related codes 1770; DDCS generates and displays an IPP checklist and/or any required forms for the recommended medical intervention diagnosis and related codes (CPT and/or diagnosis) 1780; physician and/or staff completes any missing information from the insurance authorization checklist 1790, which may include recall of information from one or more previous visits from the relevant visit database to prepopulate the insurance authorization checklist and required forms with completed information from one or more previous visits 1800; display updated IPP checklist and required forms with completed information from one or more previous visits; DDCS displays progress of IPP submission process; notify and/or display to physician/clinician of any missing information from the insurance authorization checklist and required forms; send, share, store, and/or print completed insurance authorization checklist, required forms, test results, images, and/or letters to patient electronic health record, hospital, physician/clinician, insurance payor, clinical practice and/or any 3rd party; recall one or more previous visits from the relevant visit database to prepopulate the IPP summary with preoperative plan with completed information from one or more previous visits 1810; and/or display updated preoperative visit and insurance authorization summary with completed information from one or more previous operative visits; DDCS displays progress of IPP submission process; transmit completed IPP to insurance payor 1820; insurance payor sends immediate approval or denial (with comments and flags) to DDCS 1830; DDCS displays progress of IPP submission process; DDCS analyzes and stores statistics of the submission/resubmission IPP process for future or immediate review by the physician/clinician and/or office staff 1840; DDCS analyzes and stores statistics of denial information and make automatic adjustments or updates to insurance payor (i.e., a “smart” or learning system), insurance policies, standard/prepopulated IPPs, and/or any combination thereof.

In one exemplary embodiment of the DDCS hosted insurance authorization module 1680, the DDCS may acquire and/or maintain a list of preauthorization criteria for the major insurance payors, insurance payor policies and relevant insurance payor procedures. The DDCS may acquire standardardized preauthorization criteria and/or checklists from a plurality of insurance payors policies and/or procedures and store the standardized preauthorization criteria and/or checklists within a remote server. Alternatively, the DDCS may distill the content of the insurance payor policies and procedures and create custom checklists of preauthorization criteria that may be used a common form within the physician/clinician practice. The standardized and/or custom preauthorization checklists may be stored for future use by the physician/clinician and/or staff, and the stored information may be easily accessible through the named insurance payor and the policy type (i.e., policies that may apply to procedures—cervical fusion, lumbar fusion, shoulder resurfacing, cardiac, knee, etc). By collecting and/or distilling the preauthorization criteria checklists from the plurality of insurance payors, the physician/clinician practice may become quickly familiar with the requirements that are ultimately common among the various insurance payors and increase their workflow efficiency.

In another exemplary embodiment of the DDCS hosted insurance authorization module 1680, the DDCS system may acquire the relevant patient insurer payor information by electronic medical health record, DDCS remote storage as described herein, and/or entered manually as a new patient (as described herein). For example, the DDCS may allow syncing to the physician/clinician electronic health record (EHR) system. The relevant patient information may be entered into the DDCS by an automatic HLY interface, allowing the patient's insurer information to be entered automatically.

In another exemplary embodiment of the DDCS hosted insurance authorization module 1680, the DDCS may include the presentation of a trial insurance preauthorization packet (IPP). The physician/clinician and/or staff may require log-on and authentication to the DDCS, where the DDCS may update all the relevant modules (i.e., today's patient list, total patients seen list, insurance preauthorization policies and/or procedures, insurance preauthorization checklists, and/or any combination thereof.). Once the physician/clinician and/or staff is “logged-on,” the trial IPP may be made available through a DDCS insurance module that may be accessed through the patient dashboard or any other relevant interface. When entering the module, the physician/clinician and/or staff may request the trial IPP by entering the relevant information. The patient's insurance information may be matched with the available policies in the system and the physician/clinician and/or staff can be presented with a list of policies against which a trial preauthorization can be initiated. Furthermore, the DDCS hosted insurance authorization module, may provide for an additional interface and/or a portion of the IPP, where a list of “chief concerns” which the patient is presented with. The physician/clinician and/or staff may review the chief concern list, and/or select (or deselect) individual or all chief concern from the list. The relevant chief concern(s) that are selected may display the individual criteria required for preauthorization from the patients' insurance payor. The individual criteria may be reviewed by the physician/clinician to understand what steps must be completed. The individual criteria may be optionally available in checklist, or a pop-up screen with the criteria listed, a scrolling list, a pdf list, and/or any combination thereof. The completion of the individual criteria may occur at least one or more visits over time.

In another exemplary embodiment of the DDCS hosted insurance authorization module 1680, the DDCS may include a progress tracking feature. The progress tracking feature may be accessible by the physician/clinician, staff and/or the patient once the physician/clinician and/or staff receives the trial IPP. The progress tracking indicator feature may be privately available to the physician/clinician and/or staff, where the physician/clinician and/or staff may control certain features (i.e., protect confidentiality, or remove or redact costs of procedures, etc.) and share the trial IPP process and progress of the trial IPP process with the patient. Alternatively, the DDCS may make the entire trial IPP process visible, where the visibility promotes transparency of the practice, hospital and/or the insurance payor processes. Should the trial IPP process be visible, the DDCS may include features that allow the patient to personally flag, highlight, comment and/or take notes on items that the patient's may have concerns or questions. The concerns or questions may be returned through the DDCS, where the concerns or questions may be presented and/or displayed to the physician/clinician and/or staff. Furthermore, the progress tracking feature may be displayed as progress indicators. Such progress indicators may be displayed in a variety of textual or graphical formats that may include a progress bar (i.e., a horizontal bar which is gradually filled with a color as the trial IPP process is completed), a simple textual percentage figure, a spinning or non-spinning pinwheel, progress window, and/or any combination thereof. As the preauthorization criterion are marked completed, the preauthorization checklist may display progress indicators to show which steps need to be taken before continuing further.

In another exemplary embodiment of the DDCS hosted insurance authorization module 1680, the DDCS can allow the physician/clinician and/or staff to develop a preoperative plan. The pre-operative plan can be a thorough account of the procedure the surgeon intends to perform. The information on the preoperative plan may include date, time of day, selected physical therapist, the regions for operation, products that may be recommended, alternative products suggested, diagnosis codes, manufacturer, available sales person, sales person contact information, and/or any combination thereof (see FIGS. 33C and 33B). The development of the preoperative plan may be queued after the trial IPP has been met. The creation of the preoperative plan may be entered manually from the physician/clinician and/or staff, or the DDCS may make recommendations on any of the information on the preoperative plan, e.g., it may be based on the type of procedure, most approved products and most successful physical therapist (or company) that have been used and approved by various insurance payors. These features could be an important component piece of the plan, as product choices often have an impact on the insurer's choice to accept or reject the preauthorization request.

In another exemplary embodiment of the DDCS hosted insurance authorization module 1680, the DDCS may allow for manual or automatic compilation of the trial IPP prior to submission. For example, if the DDCS allows for manual compilation of the trial IPP prior to submission, the physician/clinician and/or staff will have to select each relevant patient-reported data and documentation to be included in the trial IPP submission to the insurance payor. The physician/clinical may use the preauthorization checklist as a guide and “attach” items as a .pdf, word, spreadsheets, hyperlinks or html to complete the IPP. Such trial IPP may include, but not limited to patient demographic factors, the completed items from the preauthorization checklist(s), the pre-operative plan, as well as any relevant patient-reported data (Oswestry Disability Index, VAS, Oxford Shoulder scores, symptoms, drawings, xrays, diagnostic tests, diagnostic images, etc.). Once all information has been gathered, the DDCS system may convert the entire packet into a .pdf file, so the physician/clinician, staff and/or patient may print, save or share the packet at any point. The completed IPP and all corresponding documentation may be printed and submitted via fax to the insurance payor, emailed to the insurance payor, provide a remote access hyperlink (providing temporary access to the insurance payor to view and access the trial IPP), uploaded to the insurance payor website, and/or downloaded through a FTP connection and/or VPN portal. Alternatively, the DDCS system may allow for automatic compilation of the trial IPP, where the DDCS can search its own remote servers and/or search the physician/clinician EHR system for the proper patient information.

In another exemplary embodiment of the DDCS hosted insurance authorization module 1680, the DDCS may allow the physician/clinician, staff, insurance payor, and/or patient to make comments, highlights, tag or status flags to any of the items during the trial IPP process. For example, if the trial IPP packet has been submitted to the insurance payor, the insurance payor may deny the trial IPP and return the denial notice to the DDCS, where the physician/clinician, staff and/or patient may review the documentation. The insurance payor may make comments, highlights, tags or status flags within the trial IPP to describe the nature of the rejection. The physician/clinician and/or staff may review the comments and/or concerns to complete, redo, and/or resubmit the trial IPP with amended information.

In another exemplary embodiment of the DDCS hosted insurance authorization module 1680, the DDCS may optionally compile various information on the submission/re-submission process for statistical analysis. For example, the DDCS may compile, store and display statistical data regarding the submission and/or resubmission process. The statistical data may include, but not limited to, most common procedures conducted at the practice, total time to submit the trial IPP, which portion of the trial IPP process takes the longest or shortest, how long from ordering diagnostic test to the completion of test, persons responsible for collecting tests and/or reports, cost of procedures and/or products, responsible physician/clinician, and/or any combination thereof. The statistics of the submission/resubmission process may be immediately accessible for later review by the physician/clinician and/or staff to help them determine the efficacy of their internal procedures and record keeping.

In another exemplary embodiment of the DDCS hosted insurance authorization module 1680, the DDCS may optionally compile various information the approval/denial process of the trial IPPs for statistical analysis and/or automatic adjustments/updates to IPP (i.e., a “smart” or learning system), insurance payor policies, insurance payor procedures, and/or preauthorization checklists. The DDCS may analyze denial information to find policies that are being denied more often than others and/or also use the “reasons for denial” status flags, comments, highlights and/or tags. After the DDCS has compiled this information, the DDCS may automatically add preauthorization criterion to address those denials and/or update the relevant portions of the insurance module. For example, if a particular policy contains a section for conservative therapy, but is often being denied due to lack of physical therapy sessions, a “physical therapy” criteria may be added to the conservative therapy section of the checklist. Future trial IPP will desirably use this updated policy and preauthorization checklists. Furthermore, as the DDCS may also use the compiled information to inform physician/clinician and/or staff when a denial rate is out of the ordinary (for example, greater than 1 or 2 standard deviations). With this information, the system, may be able to assist individual customers to improve their processes. The statistical information and additional preauthorization criterion can even be used to identify hospitals, practices or physicians with better-than-average approval rates. Also, another advantage of the statistical information may allow the physician/clinician and/or staff to gain insight into which insurance payor policies are most successful in approval ratings and which insurance payors have most denials. Desirably, this information could improve the quality of the preauthorization checklists, trial IPPs and/or reduce future denials.

In various additional embodiments, the DDCS may include a module that provides a variety of alternative treatment options for a given patient based on various patient and treatment criteria contained in a trial IPP. For example, where a physician is seeking to implant a medical device in a given procedure, but various responses to the insurance authorization are unacceptable and/or incomplete, the DDCS may search for additional treatment options that might be approved using the current responses, and provide those additional options to the physician using drop down menus or other display options. For example, an insurer may reject a first manufacturer's device, but might allow the use of a second manufacturer's device for the same surgery based on the same patient conditions and IPP responses, so the DDCS might present the second device as an alternative option for the physician. In a similar manner, the DDCS may include drug/device price, payment and/or reimbursement information for a variety of procedures and/or devices, potentially including physician and/or hospital reimbursement information, which might be useful by a variety of individuals in deciding on treatment options.

The addition of a DDCS hosted or Insurance payor hosted insurance authorization module may improve workflow efficiency because the DDCS software may prohibit and/or reduce the opportunity for the physician/clinician sending incomplete documentation, rules and/or requirements as requested by the insurance payor. The sending of completed documentation, rules and/or requirements to the insurance payor may reduce the burden to the physician/clinician when handling the number of rejections, requests for additional information, and/or appeals to the insurance payor. Furthermore, the insurance payor may also reduce the amount of time and personnel expended in addressing the existing number of rejections, requests for additional information, and/or appeals.

Professional Education Module (PEM)

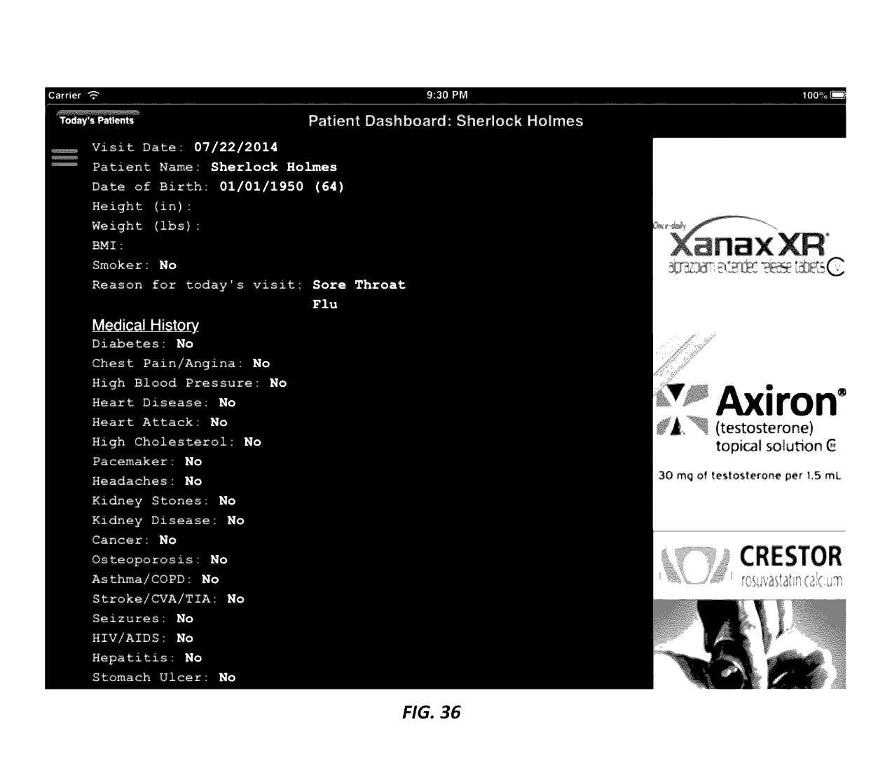

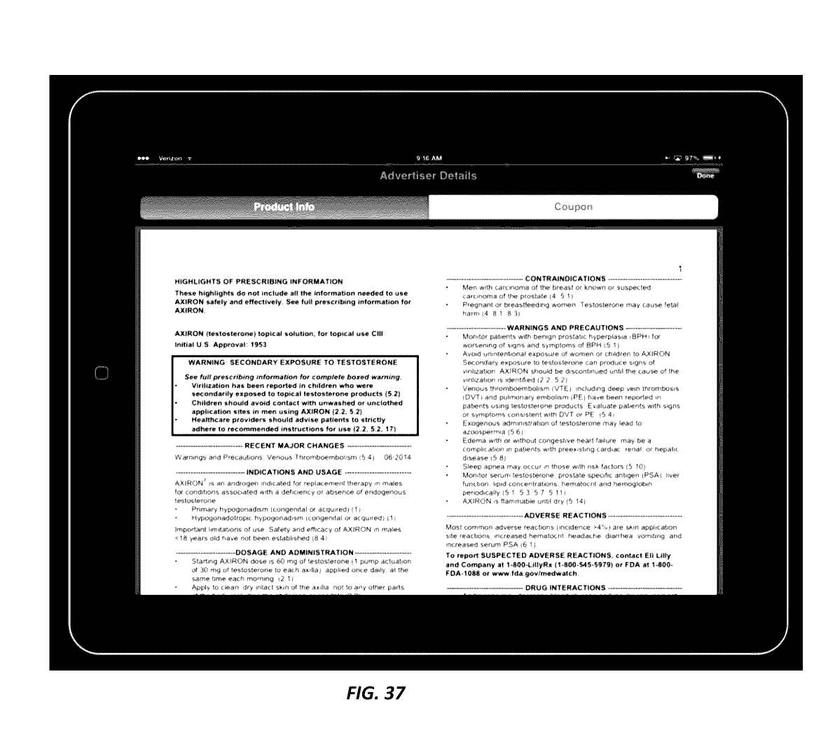

In some exemplary embodiments, the DDCS may contain an optional module for dissemination of information, educational materials and/or advertising targeted to physicians or patients (i.e., a professional education module or PEM), as seen FIGS. 36 and 37. The module may contain several different operational components, which may include at least one of a campaign database, patient snapshot component, patient portal, an educational component (i.e., may include a surgeon dashboard, surgeon portal or any combination thereof), analytics dashboard component, and/or any combination thereof.

In one exemplary embodiment, the DDCS PEM may include an optional campaign database. One or more advertising campaigns can be acquired from one or more third party companies that wish to use the DDCS as an electronic media platform tool to generate attention, enthusiasm, demand and/or entice a significant number of a targeted audience to induce the purchase or use a specific piece of information, product, pharmaceutical, educational material, and/or any combination thereof. These campaigns may employ an intentional and carefully coordinated series of marketing tools in order to reach the target audience. In various embodiments, the DDCS may allow for the third party companies to enter specific criterion to reach a specifically targeted audience, where the targeted audience may include the physician/clinician, staff and/or patient. Such criterion may include begin and end dates of a campaign or offer, types of physician practices to target, types of select patient, physician/clinician and/or staff demographic factors, select insurance companies, and/or types of dissemination of materials (i.e., product, pharmaceutical, educational materials or any information, etc.). The criterion for each campaign may be stored in a storage database (local and/or remote) where the data may be easily accessible and searchable. In various designs, these criterion may be maintained as Foreign Key relationships to the Campaign table database, where the Key may establish and/or enforce a link and/or filter between other DDCS databases, including patient information, physician/clinician, staff, surveys, questionnaires, any other databases described herein, and/or any combination thereof.

In another exemplary embodiment, the DDCS PEM may facilitate the dissemination of various types of targeted information, including information relating to a patient-specific ailment and/or medical condition, with this information targeted for the viewing of a physician/clinician and/or staff. Such disseminated information may include at least one of (1) targeted pharmaceutical advertising; (2) targeted medical device (implant) advertising; (3) physician educational materials, classes, conferences, etc.; (4) discounts or coupons for either pharmaceutical or implant use; (5) relevant clinical studies based on current patient data and the study inclusion criteria; (6) PDF's from manufacturers that outline product benefits; (7) interactive videos describing the products or pharmaceutical offered; (8) any instructions and/or indications for use for product(s) or pharmaceutical(s) offered; (9) website links to manufacturers (customized or standard); and/or (10) any combination thereof. Furthermore, the disseminated information may be dynamically laid out as a series of pages, for example, a product information page, a coupon page, a video page, a website page, etc., where the physician/clinician, staff and/or patient may view the available information either directly or via a selectable link.

In another embodiment, the DDCS system may collect patient information according to new and/or existing collection and entry methods, including those described herein (see FIGS. 4 and 5), where the patient information may be displayed in patient snapshot component. The patient snapshot component may include a brief summary of a patients' current and past medical history, past and/or current symptoms, complaints, medications, surgeries, VAS scores, Oswestry scores, and/or any combination thereof. The medical history may be derived from a range of standard questions, custom questions, or may be synced from the patients' electronic health record (EHR). These questions may be independent and/or categorized into groups (i.e., neck pain questions, back pain questions, follow-up visit questions, etc.). If desired, all questions may be administered on the client device and the data stored in a database library. The DDCS may automatically strip personally identifying information from a given record and/or portion of information to prepare for remote data storage and/or storage in a data warehouse (see FIG. 4). If the information is stored in a data warehouse, the DDCS may allow access to third parties to interact with the stored information. The third parties may be able to view campaign statistical data, reporting data, clinical trial, generic patient demographics, etc. Furthermore, a database processor may organize the data for the physician and may also highlight any highly variable and/or different information and/or changes in medical history results from the last office visit or lower/higher than expected medical history results. In various embodiments, the system may employ feedback and/or other analytical processes to improve the system's ability to process, analyze and present data to the physician, i.e., a learning system. If desired, the physician may share the patient snapshot on the physician dashboard or forward to a patient dashboard for a patients' own private viewing.

In another embodiment, the DDCS PEM and/or any of the operational components may provide targeted or predicted information (i.e., “smart” or learning systems) to physicians and/or patients by utilizing a variety of factors, including (but not limited to) the (1) assigned patient identification number; (2) utilizing any of the patient-specific aggregated data stored in the DDCS data base library; (3) any data acquired directly from a patients' electronic medical health record (PEHR) to index selected data; (4) patient clinical past and current history, such as patient demographics (gender, sex, age, etc.), diagnosis (CPT codes), diagnostic results, family history, office visits, reason for visit, hospitalizations, treatments (wearable, therapies, or any other treatments known in the art), medications, implants, and/or type of insurance; (5) physician customs in specific geographic locations; (6) patient indications and/or contraindications (i.e., companies/manufacturers might deliver lists of reasons why a patient shouldn't be marketed to) (7) geo-targeting (i.e., the practice of delivering targeted information to a website user based on his or her geographic location); (8) third party cookies (i.e., using website search data, purchase data, and any personal profile data); (9) sales percentage of product or pharmaceutical sales at the physician's office, clinic or hospital; (10) which campaigns are currently active (by start/end dates); (11) physician's practice type (i.e., cardiologist, family doctor, orthopedic, dermatology, etc.); and/or (12) physician's membership in a targeted list designed by the manufacturers. The DDCS may utilize one or more of these factors to query the list of ongoing campaigns to find matching or substantially matching campaigns. Once the matching or substantially matching campaigns are located, the DDCS may compile a list of the disseminated information. Such indexed information may be used to create a profile for a specific physician and/or patient and the indexed information may automatically distribute or display the targeted information to a specific dynamic graphical user interface (GUI), such as any of the DDCS modules. The GUI may include advertising space on various client devices, office note visit summaries, on a physician portal, on a patient portal, on the DDCS launch screen, on a 3D virtual model where the pain is located/selected, and/or any other medium which can be tailored and targeted to a specific physician and/or patient. Once the disseminated information is tapped and/or accessed for further review, a tracking record can be created, linking the Campaign ID, Physician ID/Staff ID, date/time, patient ID, and/or any of the combination thereof.

In another embodiment, the PEM or any of the operational components may disseminate targeted information to subtly and/or overtly impel or induce a physician to modify or amend their selected course of treatment for a patient. For example, a physician may be treating a patient suffering from sciatic pain originating in the cervical region, where the patient is recommended to pursue back surgery. The PEM data processor may utilize any available data source, including one or more sets of information from (1) utilizing the patient-specific aggregated data stored in the DDCS data base library; (2) acquiring data directly from a patients' electronic medical health record (PEHR) to index selected data; (3) patient clinical past and current history, such as patient demographics, diagnosis (CPT codes), diagnostic results, family history, office visits, reason for visit, hospitalizations, treatments, medications, implants, and/or type of insurance; (4) physician customs in specific geographic locations; (5) patient indications and/or contraindications (companies/manufacturers can deliver lists of reasons why a patient shouldn't be marketed to) (6) geotargeting (i.e., the practice of delivering targeted information to a website user based on his or her geographic location); (7) third party cookies (i.e., using website search data, purchase data, and any personal profile data); (8) sales percentage of product or pharmaceutical sales at the physician's office, clinic or hospital; (9) which campaigns are currently active (by start/end dates); (10) physician's practice type (i.e., cardiologist, family doctor, orthopedic, dermatology, etc.); and/or (11) physician's membership in a targeted list designed by the manufacturers to deliver targeted cervical implants from different manufacturers, available clinical trials, and/or new pharmaceuticals that may help reduce the inflammation and pain. The physician may click on the different advertisements and may decide to change their course of treatment for the patient by recommending further non-invasive treatment by trying the new pharmaceutical. Alternatively, the system may suggest a clinical trial of which the physician was previously unaware (i.e., a “smart” or learning system), which may be using an investigational device that could be more beneficial to the patient than the standard commercial offerings.

In another embodiment, the PEM and/or any of the operational components may allow for a ranking system that rates the available targeted information for relevance. The data processor may acquire or search the PEHR or the database for the patient-specific indexed information and rank the disseminated information based on urgency, including any current need and/or future predicted conditions or diagnosis (i.e., a “smart” or learning system). Alternatively, the ranking may occur based on a prearranged priority that may be previously agreed to by the third party and the DDCS software developer. For example, the data processor may acquire information regarding a male patient with chronic history of high cholesterol and intermittent high blood pressure over the last several visits, and may prioritize (i.e., a “smart” or learning system) the information regarding statins (pharmaceutical), beta blockers/ACE inhibitors, and future clinical studies available that may match the patient inclusion criteria. The data processor can then rank this information based on urgency and patient history, and/or prearranged agreement. The statin information may be delivered automatically to the dynamic graphical user interface of the physician's client device, where the beta blocker/ACE inhibitor and clinical study information may be delivered subsequently (i.e., automatically) or on an as-selected basis by the physician (i.e., the physician may choose to ignore subsequent information due to the fact the medical need is unnecessary). Furthermore, the data processor may operate to continuously search and acquire new data from the PEHR or DDCS data library, and process this new information to update the disseminated information and/or re-rank the information. If desired, the data processor may perform the ranking based a variety of factors, which could include scoring or weighted averages systems, or various other rating systems that are known in the art.

In another embodiment, the DDCS PEM and/or any of the operational components may allow for viewing of campaign statistical data in specific analytics dashboard component or via any other designated module. The specific analytics dashboard may allow third parties to analyze a plurality of targeted audience metrics to tailor marketing activities, which may include metrics that help the third parties analyze and understand who their main targeted audience will be and their needs (i.e., to paint a picture of each person and/or an aggregation of each physician's practice), track the routes and/or electronic “paths” that each targeted audience take to reach the disseminated information (which can help enhance audience experience through analysis and incremental improvement of the system), make a visual assessment of how the targeted audience interacts with a specific piece of disseminated information (i.e., determine what the audience is looking for, what they like, etc.), identify how many “impressions” of the disseminated information were served, identify how many times the targeted audience “tapped on” or otherwise selected the disseminated information to review further detail, quantify how many pages were reviewed, identify how long the targeted audience took to view the disseminated information, determine how many times a video was watched, and/or identify how many times the review of the disseminated information led the physician/clinician to refer discounts, coupons or other disseminated information or offers to the patient. Furthermore, the analytics dashboard may provide codes or other access points for allowing personalized access by the patient and/or physician to the third party's good and/or services, via a unique URL, user identification and/or passcode. If desired, the analytics dashboard may allow third parties to create custom tailored reports for delivery to different teams and/or groups within the third party company, including custom alerts to notify team members or personnel when significant statistical variations are identified in a targeted audience, providing annotation of shared or private notes on the custom tailored reports, and/or optionally allowing third parties to change their disseminated information entirely or only partially (i.e., if an existing agreement allowing such “on the fly” modification of the information is in place). If desired, the analytics dashboard may allow the third party to capture results of specific marketing approaches, test different marketing approaches or disseminate different types of information using various features of the system.

In another embodiment, the DDCS PEM and/or any of the operational components may allow for personalization of individual physician and/or patient settings and/or configurations. Such settings and configurations may include forwarding informational content from a physician portal to a patient portal automatically, or forwarding of such information only manually, as well as how a physician might like to receive various types of information (i.e., desktop, PDA, mobile phone, or a combination, etc.), the frequency at which the targeted advertising and/or educational information is disseminated, the type of disseminated information, whether the physician or patient would prefer audio or captioned text for the disseminated information, adjustment of text size, activation of GPS locator, and/or location of disseminated information on the graphical user interface (GUI) of the client device. For example, the physician may choose to configure the PEM to accept targeted discounts/coupons for the patient and activate the GPS locator. As the patient returns for their next office visit, the data processor can search the PEHR or the DDCS database library to update and rank the selected disseminated information (i.e., a “smart” or learning system). Depending upon the physician's settings or preferences, the targeted discounts/coupons can be automatically sent to the physician's GUI, where the physician may choose to forward discounts/coupons to the patient portal, where the patient can have private access. Alternatively, the physician may desired the system to forward the targeted coupons directly to the patient's portal. Also, with the GPS activated, the GPS may optionally provide the nearest pharmacy location that accepts the discounts/coupons, as well as provide pharmaceutical cost/pricing.

In another embodiment, the DDCS PEM and/or any of the operational components may have a “checkout” feature. The “checkout” feature may allow disseminated information on the DDCS to be stored in a list for later use or accessing by a physician/clinician, staff, and/or patient. For example, if the DDCS PEM module activates sharing with the patient or has a patient specific patient dashboard, the physician/clinician and/or staff may access the disseminated information (i.e., by tapping, double-tapping, separate checkout button, drop and drag, etc.) to activate the checkout feature. Once the checkout feature is activated, the DDCS can match the patient's ID and place the disseminated information list into a queue with a record of the materials the patient should receive. Once the patient has completed their office visit, the staff can glance at the checkout feature queue and distribute the appropriate materials to the patient. A single tap could automatically print coupons if they're being offered digitally. The activation of the checkout feature can also generate a tracking record for compilation and statistical analysis by third parties within the analytics dashboard.

In another embodiment, the DDCS PEM and/or any of the operational components may allow for contracting with a variety of vendors and/or physicians to provide targeted information to physicians and/or patient regarding the vendors′/physicians' products and/or services. For example, such vendors may include at least one of pharmaceutical sales, device distributors, device manufacturers, clinical study providers, professional organizations, etc. The vendors may be charged various types of fees to place their targeted information about their products and services on the module, which may include a monthly fee, a one-time fee, a per-ad fee for each ad presentation to a physician and/or patient and/or a use fee reflecting actual use and/or purchase of a good or service.

In various alternative embodiments, a physician may also want to provide targeted information regarding their products or services or receive targeted information on the module or any of the operational components. If the physician decides to provide targeted information regarding their products or services on a module and/or any of the operational components, then the physician may pay advertising space fees to the DDCS software developer. Where a physician decides to receive a DDCS with a PEM, however, the DDCS software developer may decide to offer a discount and/or credit towards the costs of the system for the physician, which could include (1) charging a discounted fee to physicians selecting to receive the DDCS containing targeted information from other vendors; (2) providing the system free-of-charge or reimbursing a physician's monthly fee, possibly determined on a per-month basis, and/or (3) pay a physician a small fee for placement of the system.

An example can help to illustrate many of the implementation and operation features of one embodiment of the disclosed systems and processes. A patient may travel to a physician's office fto seek treatment or for a regularly scheduled office visit. The patient can take a survey, and this survey may contain a range of questions about the patient's medical history and current symptoms/complaints—to help identify the primary reason for the visit. This list of questions can be provided by each participating physician, and the different types of questions (i.e., standard and/or custom questions) will generally follow some basic logical course, with various questions asked that seek to elicit patient responses and identify/target the patient's current problems. In many cases, where the patient has previous data available, the questions may be more focused (i.e., ask neck questionnaires to people with neck problems, ask post-op or follow up questions if someone has had a procedure), or the questions may be more “open-ended” to elicit and identify more general problems (i.e., “are you feeling tired today”). The patient will desirably complete the survey, and all the data is collected and prepared for the physician's review, as well as potentially collected, analyzed and/or used for the dissemination of targeted advertising (among the various other factors mentioned herein). A data processor may highlight exceptional information (like higher-than-average pain scores, for example) and if the patient has taken the survey before, identify and highlight the deltas/changes in the answers. The summary of the patient information (i.e., a snapshot that may include an at-a-glance information of how the patient just responded to the questionnaires) may be displayed on the physician portal to allow the physician to share the summary information (snapshot) with the patient or forward to their patient portal for private viewing access.

As previously mentioned, the data collected from the survey and/or questionnaires may be used to disseminate targeted information regarding the patients' ailment or medical condition to the physician portal. The targeted information may appear in a gutter or in a banner next to or proximate to the snapshot. One of the many features of the banners and/or gutter may denote certain characteristics of that module including whether or not a product is “formulary” for the patients insurance provider, also whether a coupon or special offer is available to that patient, as well as any other information described herein. The displayed information on the banner and/or gutter may be highly interactive, where the information may be standard information and/or marketing materials available from the manufacturers, or the information may be customized to varying degrees for the physician's and/or patient's viewing and understanding. Such information that may be viewed in a banner and/or gutter may be a list of hyperlinks to custom or standard designed webpages, or PDF's from manufacturers that outline product benefits, coupons for distribution to the patient, interactive videos describing products offered, instructions for use on products offered, and/or any combination thereof.

The physician may review the targeted information, which may include a proposed diagnosis derived from the various survey responses, and the targeted information may include information that assist the physician become aware and/or more aware of treatments, coupons, implants or clinical studies of which the physician may not have been previously aware of. If desired, the information may include a selectable link or other tab if the physician desired additional information and/or further investigation. A physician may use the targeted information to change or amend the physician's original intended and/or selected course of treatment for a patient. Also, if a physician becomes aware of a discount and/or coupon, the physician may notify the patient of the availability of a coupon. If the physician decides to print coupon for patient or otherwise make the item available for the patient, it may simply require activation of a click button and that patient's information can be inserted into a queue for later processing. This queue can be managed by the physician staff at the front desk, and the coupon (and/or an automated prescription for the item, which may form part of the coupon form) can be provided to the patient upon checkout. Desirably, the staff could simply click the patient's information and/or medical record number in the packet of coupons, and the relevant information will be printed automatically for physical and/or electronic distribution and/or forwarded to the patient's private patient portal—which may be based on the patient's preference.

In various embodiments, as a physician interacts with the modules and/or any of the operational components, the module may keep a historical track of the physician's and/or patients' activities. In various systems, certain activities and/or successful advertising and sales results might result in higher tiers of fees being charged to the advertisers (i.e., a “smart” or learning system). The system can track a wide variety of metrics, and some of the items that may be tracked may include impressions of that company's/manufacturer's targeted information, the number of clicks on the banners or gutters, the number of type of coupons or packets distributed to patients, the number and types of videos watched, and/or other factors as described herein. The detailed tracked information can be stored in a separate database where a data processor may summarize the information and communicate it through a private analytical dashboard that may be available to the participating manufacturer or organization.

All of the embodiments described herein can include features having a much broader range of applicability. In particular, aspects of the present invention should not be limited to any particular kind of orthopedic procedure and could be applied to other practice areas in which outcome reporting can be of use. Such practice areas could include orthopedic, cardiac, pulmonary, peripheral vascular, neurology, etc. One of ordinary skill in the art should recognize other variants, modifications, and alternatives in light of the foregoing disclosure.

The invention may be embodied in other specific forms without departing from the spirit or essential characteristics thereof. The foregoing embodiments are therefore to be considered in all respects illustrative rather than limiting on the invention described herein. Scope of the invention is thus intended to include all changes that come within the meaning and range of equivalency of the descriptions provided herein

Many of the aspects and advantages of the present invention may be more clearly understood and appreciated by reference to the accompanying drawings. The accompanying drawings are incorporated herein and form a part of the specification, illustrating embodiments of the present invention and together with the description, disclose the principles of the invention

The various headings and titles used herein are for the convenience of the reader, and should not be construed to limit or constrain any of the features or disclosures thereunder to a specific embodiment or embodiments. It should be understood that various exemplary embodiments could incorporate numerous combinations of the various advantages and/or features described, all manner of combinations of which are contemplated and expressly incorporated hereunder

The use of the terms “a” and “an” and “the” and similar referents in the context of describing the invention are to be construed to cover both the singular and the plural, unless otherwise indicated herein or clearly contradicted by context. The terms “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., i.e., “such as”) provided herein, is intended merely to better illuminate the invention and does not pose a limitation on the scope of the invention unless otherwise claimed. No language in the specification should be construed as indicating any non-claimed element as essential to the practice of the invention

The entire disclosure of each of the publications, patent documents, and other references referred to herein is incorporated herein by reference in its entirety for all purposes to the same extent as if each individual source were individually denoted as being incorporated by reference.

What is claimed is:

1) A method of enhancing an insurance preauthorization approval request for a patient, comprising:
sending an initial request to at least one patient insurance database, the initial request including target patient information;
receiving from the at least one patient insurance database a list of insurance eligibility criterion related to the target patient information;
utilizing the target patient information to query a patient database and identify patient-specific medical information; and
utilizing the patient-specific information to populate the at least a portion of the eligibility criterion and create a trial insurance authorization packet.

2) The method of claim 1, further comprising:
transmitting the trial insurance authorization packet to a third-party insurance payor.

3) The method of claim 2, further comprising:
receiving a coverage response from the third-party insurance payor.

4) The method of claim 3, further comprising:
receiving a non-coverage response from the third-party insurance payor.

5) The method of claim 4, further comprising:
analyzing the non-coverage response and identifying at least one reason for denial of coverage.

6) The method of claim 5, further comprising:
utilizing the at least one reason to modify the insurance eligibility criterion in the at least one patient insurance database.

7) A method of submitting a request for health insurance coverage for a patient, comprising:
receiving at a host computer system a first request from a provider, the first request containing information that identifies the patient and a proposed treatment regimen for the patient;
the host computer system utilizing at least a portion of the information in the first request to directly access a first patient database, the first patient database containing payor information and heath condition information associated with the patient, the host computer system identifying a payor associated with the patient and identifying a treatment protocol associated with the identified payor which corresponds to the proposed treatment regime;
the host computer system utilizing the identified payor information and identified treatment protocol to directly access a second database containing a list of approval criteria associated with the identified payor and identified treatment protocol, the list containing at least a plurality of undefined items, each of the plurality of undefined items having a predefined approval condition range, the host computer pre-populating substantially all of the plurality of undefined items using information obtained directly by the host computer, the host computer system verifying that the pre-populated items include values which fall within the predefined approval condition ranges for the associated undefined items;
the host computer system sending a first response to the provider, the first response containing the list of approval criteria, including the pre-populated items; and
receiving at the host computer system a second request from the provider, the second request containing the list of approval criteria, including the pre-populated items, the second request further including an authorization from the provider to submit the list of approval criteria and pre-populated items to the provider.

8) The method of claim 7, wherein the host computer pre-populates at least one of the plurality of undefined items using information obtained from the first request.

9) The method of claim 7, wherein the host computer pre-populates all of the plurality of undefined items using information obtained directly by the host computer from the first database.

10) The method of claim 7, wherein if the host computer system determines that at least one of the items in the list of approval criteria of the second request includes an undefined item, the host computer system sends a second response to the provider identifying the determined undefined item.

11) The method of claim 7, wherein if the host computer system determines that none of the values of the items in the list of approval criteria in the second request fall outside of the respective predefined approval condition ranges for each item, the host computer sends a second response to the provider confirming health insurance coverage for the proposed treatment regimen.

12) The method of claim 7, wherein if the host computer system determines that at least one of the values of the items in the list of approval criteria in the second request falls outside the respective predefined approval condition range for that item, the host computer sends a second response to the provider identifying the value of the item in the list of approval criteria in the second request that falls outside the respective predefined approval condition range for that item.

13) The method of claim 12, wherein the host computer includes the predefined approval condition range for the item having a value falling outside the respective predefined approval condition range in the second response.

14) The method of claim 7, wherein the first and second databases comprise a single database.

15) The method of claim 7, wherein the second database comprises a database maintained by the identified payor.

16) A method of providing directed educational, advertising or marketing materials to a target audience, comprising:
receiving at a host computer system a request from a provider, the request containing information that identifies a patient;
the host computer system utilizing at least a portion of the information in the request to directly access a first patient database containing medical information associated with the patient;
the host computer system utilizing at least a portion of the medical information associated with the patient to directly access a second database containing targeted disseminated information being associated with a plurality of defined target factors;
the host computer system comparing the at least a portion of the medical information to one or more of the defined target factors to identify disseminated information in the second database that meet the defined target factors; and
the host computer system sending a response to the provider, the response including the disseminated information that meet the defined target factors.

17) The method of claim 16, wherein when the host computer compares the at least a portion of the medical information to the one or more of the defined target criteria, the host computer ranking the resulting disseminated information relative to each other.

18) The method of claim 16, wherein the targeted disseminated information is at least one of an educational information, pharmaceutical information, medical product information, available clinical studies, websites, interactive videos, discounts, coupons, and any combination thereof.

19) The method of claim 16, wherein the target factors is at least one of patient information, provider information, patient insurance information, geographic locations, and any combination thereof.

20) The method of claim 16, further comprising the host computer system receiving a request to update disseminated information in the second database based on at least one of patient urgency, patient current medical condition, patient medical diagnosis, and any combination thereof.
